(19) United States
(12) Patent Application Publication
(10) Pub. No.: US 2007/0255611 A1
(43) Pub. Date: Nov. 1, 2007

(54) Order distributor

(76) Inventors: Csaba Mezo, Debrecen-Jozsa (HU); James Van Vleet, Fargo, ND (US); John Jasper, Arlington Heights, IL (US); Szabolcs D. Suranyi, Debrecen (HU); Peter T. Foldi, Hajdusamson (HU); Peter Balogh, Tiszaujvaros (HU)

Correspondence Address: BRINKS HOFER GILSON & LIONE, P.O. BOX 10395, CHICAGO, IL, 60610, US

(21) Appl. No.: 11/512,899

(22) Filed: Aug. 30, 2006

Related U.S. Application Data
(63) Continuation-in-part of application No. 11/411,705, filed on Apr. 26, 2006.

(51) Int. Cl. G06Q 10/00

(52) U.S. Cl. 705/9

(57) ABSTRACT

An order distributor intelligently matches agents with customers based on a number of factors to achieve a substantial match with the customer's needs, the business' needs and the agent's capabilities to meet those needs. The order distributor may consider a number of factors relating the capabilities of individual agents as well as the requirements specified by the client-company resulting in improved interaction with the customer and increased satisfaction.

### RELATED APPLICATIONS

This application is a continuation-in-part under 37 C.F.R. § 1.53(b) of U.S. patent application Ser. No. 11/411,705 filed Apr. 26, 2006 (Attorney Docket No. 12764/4) now U.S. Pat. No. ______, the entire disclosure of which is hereby incorporated by reference.

### BACKGROUND

In the services and retail industry, there is a trend towards automating customer interactions to lower costs and improve quality of service, such as through the use of Interactive Voice Response systems (“IVR”). However, many businesses, such as retail establishments, restaurants, etc., still rely on person to person interactions, i.e. employee to customer, whether in person, via the phone or other communications medium, to meet customer expectations, maintain customer satisfaction and deliver an overall requisite personal and interactive customer experience. For example, many companies use live agents, accessible via telephone communications or the like, to receive orders, provide customer service and/or generally communicate with customers. Such businesses, like all businesses, further require efficient use of employees' time and company resources to control costs while meeting the desired service goals.

In many cases, it is unacceptable to replace live agents with automated systems as, often times, such automated systems tend to increase customer annoyance, dissatisfaction, etc. Accordingly, companies must provide and train employees to handle customer communications. Alternatively, a company may choose to outsource the handling of such communications, e.g. phone calls, received from customers. For example, a company may contract with such a service and thereafter, individual incoming calls from customers may be routed to the external agent or call center who deals with the customer on behalf of the business. The outsourcing of a call between a customer and an agent may result in increased efficiency because the company is no longer required to provide, maintain and train its own employees to handle the calls. Further, given the singular nature of the task that they perform, the external agents may be more efficient than the employees of the business at handling the customer calls, which may result in a cost savings for a company above and beyond the cost of hiring this third party.

Whether provided by the business itself or by a third party, a plurality of live agents may be provided to handle the influx of customer calls. These agents are typically located in a central location, referred to as a call center. The call center typically features workspaces for all of the agents, including communications equipment, such as telephones and computers, for each agent. The communications equipment is typically interconnected with a call distribution system which is, itself, connected with the incoming communications links, e.g. telephone lines. The call distribution system typically consists of an automatic call distributor (“ACD”), described in more detail below.

In a typical operation, a customer calls a designated telephone number or otherwise initiates a communications session with a company's order or customer service operation. The call is received by an ACD at the company's, or alternatively, a third party's, call center. The ACD then routes the call to a particular agent for handling. Agent and customer pairings are typically based solely on agent availability, i.e., incoming customer calls are queued and the next available agent is matched with the next customer. Alternatively, data captured from the caller, such as via an interactive voice response system, or based on the telephone number dialed by the caller, may be provided to the ACD and used route the call to a group of agents that have been previously categorized, whereby the call is routed to the next available agent in the group. This pairing of agents with customers is somewhat random because there are no special considerations made as to the agent's characteristics and/or capabilities or the particular requirements of the customer and/or company. Specifically, there is no consideration of the many possible factors that may result in a more efficient and successful matching between the customer and an agent. This results in inefficiencies in call handling, customer dissatisfaction, increased costs and lost revenue.

Accordingly, there is a need for a system which establishes communications sessions between customers and live customer service agents wherein the system matches a given customer with a live agent in an efficient and effective manner so as to improve customer satisfaction, reduce costs and increase revenue.

### BRIEF DESCRIPTION OF THE DRAWINGS

FIG. 1 is a diagram showing the various parties and the interactions therebetween as may occur in the disclosed embodiments;

FIG. 2 depicts a block diagram of a system utilizing an order distributor according to one embodiment;

FIG. 3 is a diagram of showing exemplary inputs to the order distributor of FIG. 2;

FIG. 4 is a block diagram of the order distributor of FIG. 2 according to one embodiment;

FIG. 5A is a flowchart depicting exemplary operation of the order distributor of FIG. 4 according to one embodiment;

FIG. 5B is a flowchart depicting exemplary operation of the order distributor of FIG. 4 according to an alternate embodiment;

FIG. 6 is a chart depicting an exemplary stepwise remapping function for use with the disclosed embodiments;

FIG. 7 is a chart depicting an exemplary linear remapping function for use with the disclosed embodiments;

FIG. 8 is a chart depicting an exemplary LaGrange remapping function for use with the disclosed embodiments;

FIG. 9 is a chart depicting an exemplary Hermite remapping function for use with the disclosed embodiments; and

FIG. 10 is a block diagram of an exemplary computer system for use with the disclosed embodiments.

### DETAILED DESCRIPTION OF THE DRAWINGS AND THE PRESENTLY PREFERRED EMBODIMENTS

The disclosed embodiments relate to an order distributor that intelligently matches agents with customers, based on a variety of inputs, such as the skills, characteristics, or capabilities of the agent, etc, needs, requirements or specifications of the client, business or customer, etc., agent, client or customer properties, parameters, or other relevant data or combinations thereof, to achieve a substantial match between the customer's needs and/or the business' requirements and the agent's characteristics and/or capabilities to meet those needs and/or requirements. In one embodiment, the order distributor considers a number of inputs related to the capabilities of individual agents as well as the requirements specified by the client-company resulting in a pairing characterized by improved interaction with the customer and increased satisfaction, cost-efficient and effective transaction handling on behalf of the client-company and/or service provider, or combinations thereof. Additionally, these pairing are more likely to result in an efficient transaction that satisfies the customer and the client-company and helps to maximize the profits of the company.

The disclosed embodiments further relate to an order distributor which, upon receiving an indication of the presence of a customer at a point of service of a business and waiting to be serviced by a point of sale agent, such as a non-telephonic indication thereof, evaluates properties relating to: the customer's needs; the business' requirements and/or specifications; the capabilities of the point of sale agents that are at the disposal of the order distributor; or combinations thereof. Based on this evaluation, the disclosed order distributor then selects a point of sale agent who may then initiate a session, e.g. an audio connection, with the customer, or alternatively, to which a customer may initiate a session, in order to service that customer in accordance with the business' operations. Where the order distributor and point of sale agents are provided by a third party service provider as a service to the business, the order distributor may further evaluate the requirements and specifications of the service provider in selecting a point of sale agent. The evaluation computes a selection of an agent based on factors which most closely balances the respective goals of the participants, as well as balances the need for a rapid determination. As can be seem, whereas an automatic call distributor distributes incoming telephone calls to respective agents who then handle the routed call, the disclosed order distributor, according to one embodiment, distributes incoming order requests to respective agents who then initiate communications with the requestor, i.e. the waiting customer. This arrangement facilitates efficient high-volume transaction handling capability independent of the medium of communication and independent of the location of the customers and/or the agents.

To clarify the use in the pending claims and to hereby provide notice to the public, the phrases “at least one of <A>, <B>, . . . and <N>” or “at least one of <A>, <B>, . . . <N>, or combinations thereof” are defined by the Applicant in the broadest sense, superseding any other implied definitions herebefore or hereinafter unless expressly asserted by the Applicant to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

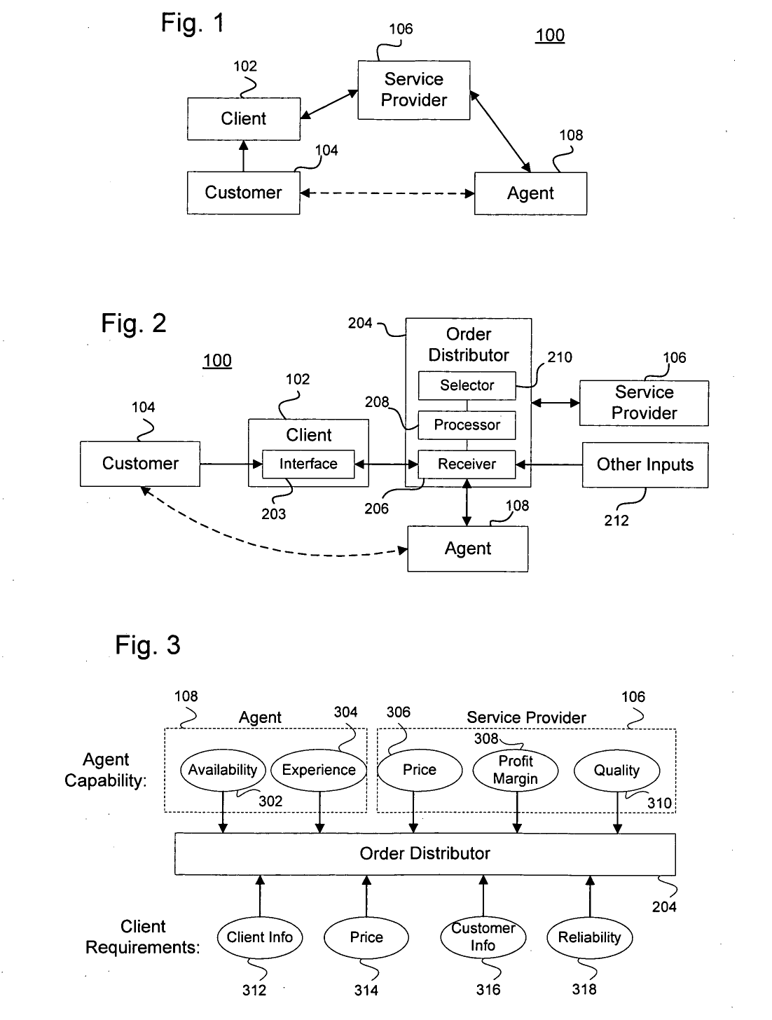

FIG. 1 is a diagram showing the various parties and the interactions therebetween as may occur in the disclosed embodiments of the order distributing system 100 described herein. In one embodiment, the order distributing system 100 includes a client 102, a service provider 106, one or more agents 108 to service one or more customers 104 which interface with the client 102, or combinations thereof. The client 102 may utilize the service provider 106 to match one of the agents 108 with the customer 104.

The client 102 may be a store or other business, company or corporation. In one embodiment, the client 102 is an entity that utilizes a live agent 108 to speak with and handle transactions or orders with customers 104 and may include a retail store or other business that handles transactions or orders for customers. In one embodiment, the client 102 is a fast food or quick-serve restaurant and the transactions include processing orders for food from a customer 104 located at a drive-through window or other point of sale location within the restaurant. In alternate embodiments, the client 102 may be a retail store providing either goods or services wherein the customers 104 interact with agents 108 to purchase products, to obtain technical support/customer assistance, or to obtain more information about the store's goods and/or services.

In one embodiment, the customer 104 may be any entity, including individuals, groups, businesses, etc., that would like to use, purchase, or obtain more information on the goods/services of the client 102. For example, the customer 104 may be placing an order with the client 102. Alternatively, the customer 104 may perform a different type of transaction, and merely needs information from the client 102. As discussed above, for a fast food restaurant client 102, the customer may be an individual present at a drive-through lane placing, or seeking to place, an order for food or related products with the store/client 102.

In one embodiment, the service provider 106 is an entity that, as will be discussed below, intelligently matches the customer 104 with an agent 108. The service provider 106 may be owned and operated by the client 102 or may be a third party who is hired by the client 102 to match agents 108 with that client's customers 104. In one embodiment, the service provider 106 manages and controls a group of affiliated agents 108, centrally located, such as at a call center and/or remotely located/distributed, such as at the agents' 108 own homes. Alternatively, the agents 108 may be independent of the service provider 106, such as independent contractors, etc. The service provider 106 receives inputs from the client 102, the customer 104, the agent 108, or any other source or combination thereof. These inputs provide information used to match a particular customer 104 with a particular agent 108.

The agent 108 is an entity that may handle various forms of customer communications on behalf of a client 102. For example, a live agent 108, i.e. a person, operator, representative, etc, may receive communications, such as a phone call from a customer 104 or, alternatively, a request, e.g. non telephonically, to initiate a communications session, e.g. an audio connection, with a waiting customer 104, and services/addresses the needs of the customers 104. Agents 108 may be located in one or more call centers, more accurately referred to as order centers, or remote therefrom, such as in their homes. In one embodiment, the handling of an individual customer is assigned/routed to an agent 108 or call center who will deal with the customer on behalf of the client 102. The agent 108 may be specially trained and have experience in handling customer calls. In one embodiment, the agent 108, in response to a indication of the presence of a customer 104 at a point of sale, initiates a communication session with that customer 104 and subsequently receives an order for goods from the customer 104, the order being provided to the client 102, as it is received or upon completion, so that the goods may be provided by the client 102 to the customer 104, either directly or indirectly. The agent 108 receives the order and transmits the information to the client 102, so the client 102 can prepare and deliver the goods to the customer 104 and, if necessary, collect payment with respect thereto. As discussed above, there may be a plurality of agents 108 from which an optimal agent 108 is selected to be matched with a particular customer 104.

FIG. 2 depicts a more detailed block diagram of the order distributing system 100 utilizing an order distributor 204 according to one embodiment. The system 100 includes a client interface 203 located, in one embodiment, at the client 102 and an order distributor 204, coupled with the client interface 203. Herein, the phrase “coupled with” is defined to mean directly connected to or indirectly connected through one or more intermediate components. Such intermediate components may include both hardware and software based components. The client interface 203 may act as an interface between the client 102 and/or the customer 104 and the order distributor 204, which, in one embodiment, may be owned/maintained/operated by the service provider 106.

As described above, the order distributor 204 matches the customer 104 of client 102 with an agent 108 who then is connected, or alternatively, initiates a session 214, such as an audio connection, with the customer 104 to service the customer 104. The order distributor 204 receives inputs from sources including the client 102, the agent 108, the service provider 106, or other inputs 212, or combinations thereof, that form the basis for a selection of an agent 108. In one embodiment, the order distributor 204 receives the inputs via a receiver 206, processes the data inputted via a processor 208, and selects the optimal agent via the selector 210, as will be described. It will be appreciated that the client 102 may be coupled with the order distributor 204, and similarly, the order distributor 204 may be coupled with the service provider 106, via a public or private wired or wireless network, or combination thereof, such as the Internet, an intranet, the public switched telephone network or a combination thereof, and that such connections are implementation dependent.

As discussed above, in operation of the disclosed embodiments, the client 102 will have customers 104 that each need to be matched with an agent 108. The client 102 may provide a client interface 203 that is coupled between the customer 104 and the receiver 206 in the order distributor 204 as discussed below. For example, the client interface 203 may include a customer interface (not shown), such as a speaker box, telephone, computer terminal or other interactive interface, thereby interfacing the customer 104, located at the client 102, with the order distributor 204. Alternatively, the customer interface may be separate from the client interface 203 and may utilize an independent communications medium to facilitate communications between the customer 104 and the agents 108. The client interface 203 may receive information from the customer 104 and pass that information to the order distributor 204, such as an indication that the customer is present and or waiting to place an order, information about the customer such as the language that the customer speaks, etc. In an alternate embodiment, the client interface 203 may include a store interface (not shown) that allows for the client 102 to transmit information to the order distributor 204 such as the client requirements, client status information, etc., as will be described in more detail below. In one embodiment wherein the client 102 is a fast food restaurant, the client interface 203 may further include a personal computer that monitors relevant information about the customer 104 and about the current restaurant status, such as customer queue depth, inventory, wait time, etc. The client interface 203 is configured to transmit this information to the order distributor 204. The client interface 203 may also be configured to receive information from the order distributor 204 so that the client 102 may then be informed of the status of various agents 108 and any matches that are established with its customers 104.

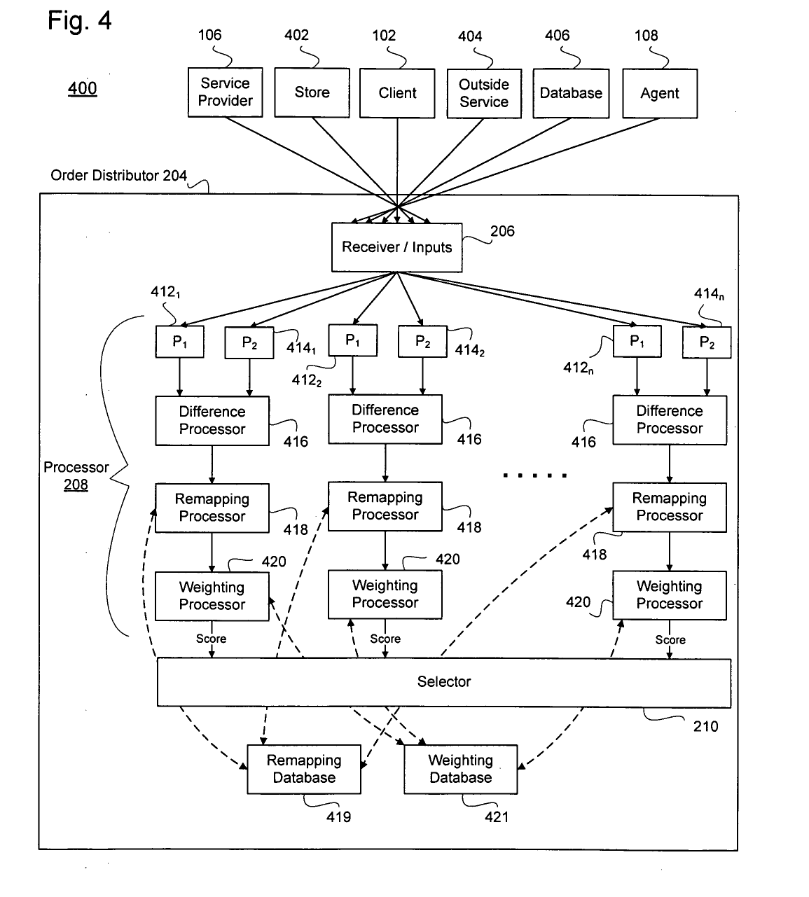

The order distributor 204 receives inputs of information and processes that information to match an agent 108 with a customer 104. The order distributor 204 may be a personal computer, or other device(s) or processor(s), and may be implemented in hardware, software, or a combination thereof. In one embodiment, the order distributor 204 includes a receiver 206, a processor 208 coupled with the receiver 206 and a selector 210 coupled with the processor 208. The receiver 206 receives various inputs, as will be described, and provides those inputs to the processor 208, which processes them, as will be described below, to allow for selection of an agent 108. The processed inputs are then provided to the selector 210 which, based on the processed data, intelligently matches a customer 104 with an agent 108. One example of the functioning of the processor 208 and the selector 210, according to one embodiment, is shown and described with respect to FIG. 4 discussed below.

The order distributor 204 may be implemented by a service provider 106 which may be a part of, or independent from, the client 102, as discussed above. In one embodiment, the service provider 106 manages and monitors the operation of the order distributor 204. The order distributor 204 may physically be located at the location of the client 102, the agent 108, the service provider 106, or any other location, or alternatively, the components of the order distributor 204 may be distributed among various locations and interconnected, such as via a network.

The order distributor 204 intelligently matches an agent 108 with a customer 104, based on received information from the client 102, the agent 108, other inputs 212, or combinations thereof, for the handling of a transaction between the customer 104 and the client 102. In one embodiment, the connection between a customer 104 and an agent 108 is established via a telephone call or other two way audio connection, using the public switched telephone network, a VoIP or other Internet based telephony protocol, or a combination thereof, via which the customer 104 and agent 108 can talk to one another to carry out a transaction. In one embodiment, this connection is initiated by the agent 108 in response to an indication that the customer 104 is present and waiting at a point of sale. Alternatively, the connection may be initiated by the customer 104, such as by triggering a presence detector or pushing a call button, etc. Wherein the session and/or connection, such as an audio connection, is initiated by the agent 108, the order distributor 204 may remain independent thereof, i.e. the order distributor 204 selects the agent 108 as described and then provides the relevant information to the selected agent 108, e.g. identifies the location of/contact information for the customer, so that the selected agent 108 may then initiate direct contact independent of the order distributor 204, thereby relieving the order distributor 204 of further responsibility for the transaction.

In one embodiment, the service provider 106 provides information to the receiver 206 of the order distributor 204 through various inputs. The matching or selection of an agent is based on any number of inputs and information related to the client 102, the customer 104, the agent 108, or other factors which may be broadly categorized as will be described below. These inputs comprise, and may also be referred to interchangeably as, factors, parameters, values, states, skills, properties, conditions, data, etc. It should be understood that the categorization of inputs described herein is implementation dependent and that additional or fewer categories may be utilized, including other categories, super-categories, sub-categories, factors, or inputs which are not explicitly discussed herein.

FIG. 3 is a diagram of showing exemplary inputs to the order distributor of FIG. 2. The relevant inputs, for the purposes of discussion, may be divided into two broad categories: agent capabilities and client requirements, i.e. store requirements, as shown in FIG. 3. Generally, these categories describe various inputs available to the order distributor 204. The category of agent capabilities describes inputs which relate to all relevant information regarding the agents 108 which are at the disposal of the order distributor 204, while the category of client requirements describes inputs which relate to the explicit or implicit needs of the client/customer/store that an agent 108 may have to meet, entirely or in part, to be selected, or considered for selection. Accordingly, one or more of the inputs described as an agent capability may correspond to one or more client requirement inputs and vice versa. It will be further appreciated that, for discussion purposes, a given category may include one or more sub-categories, themselves describing various inputs and that a given input may be described by one or more categories and/or sub-categories.

Inputs, information, etc., categorized as an agent capability include relevant data and information relating to the individual agents 108 that may be at the disposal of, or otherwise provided to, the order distributor 204 at any given time for selection to handle a given transaction. This category may include any inputs relevant to the general abilities or skills of an agent, including, as will be described, their availability. In one embodiment, one or more of these inputs are provided to the order distributor 204 and may originate from the agent 108, service provider 106, or another source. As shown in FIG. 3, exemplary inputs categorized as an agent capability include availability 302, cost or price 306, profit margin 308, experience 304, quality 310 or combinations thereof, discussed in more detail below.

Agent availability 302 refers to data representative of whether or not an agent 108, otherwise disposed to the system 100, is available to be matched with a customer 104 and receive a call. Agent availability 302 may be an input value or describe a sub-category of inputs related to the availability of an agent 108. For example, agent availability 302 may include an input provided by the agent 108 to the order distributor 204, such as an input generated by the agent 108 indicating whether or not they are available for selection, thereby giving the individual agents 108 the ability to make themselves available at those times when they choose. Alternatively, agent availability 302 may be determined automatically, by the service provider 106 or order distributor 204 by detecting when an agent 108 is logged onto a computer or workstation that is connected to the order distributor 204, such as via network. The agent availability 302 may further be determined based on recording a last used time for each agent 108, and the agent 108 who has not been used most recently may be selected.

Whether an agent 108 is available, as determined via the agent availability 302 data, may be one of the first considerations when matching an agent 108 with a customer 104 so as to immediately eliminate an agent 108 from consideration when that agent is not available. Accordingly, the order distributor 204 may quickly narrow the available pool of agents 108 based on those agents that are currently available. It will be appreciated that some inputs may be processed by the order distributor 204 in a serial fashion while other inputs are processed in parallel, and further that the processing of some inputs may result in a binary value while the processing of other inputs results in one or more of a range of values to be compared across agents 108 and/or against a scale, and that the selection and/or combinations of such processing of the given inputs is implementation dependent and are contemplated to achieve the disclosed functionality.

Information regarding agent availability 302 may further include information regarding a future time frame, e.g. denoting those agents who will be, or who are predicted/forecasted to be, available within a certain time period. For example, if an agent 108 is on a call, the order distributor 204 may select that agent 108 to handle the next match with a customer 104 knowing/assuming the current call will terminate within a short period of time and the particular agent 108 will become available to handle the selected transaction. Alternatively, if the agent 108 recently finished a call, the order distributor 204 may attempt to avoid selection of that agent 108 for a certain time period after the call ends, such as a wrap up time period, to give the agent 108 time to complete any matters related to the just-ended call and/or ready themselves for another call. Therefore, agent availability 302 may not only refer to those inputs relating to immediate availability, but also to inputs relating to availability at a certain time, e.g. upcoming availability. Conversely, agent availability 302 may further include inputs relating to agent scheduling information allowing the order distributor 204 know both when an agent 108 is going to become available, e.g. because their shift is starting, or when they are about to become unavailable, e.g. because their shift is ending. For example, wherein the order distributor 204 determines that a particular transaction may take a long time to complete, the order distributor 204 may avoid those agents 108 whose shifts are ending soon so as to avoid keeping the agent 108 over his allotted shift, paying overtime, or otherwise causing agent dissatisfaction, which may further result in poor customer service or increased/unnecessary costs. Instead, for example, the order distributor 204 may opt to pair that agent 108 with a customer whose transaction is known or assumed/predicted to be of a shorter duration, thereby maximizing the agent's 108 utilization over their allotted shift.

In one embodiment, agent availability 302 is a data value describing whether the agent 108 is available to handle a transaction or not, and itself may be derived from one or more other inputs as described above. In an alternative embodiment, agent availability 302 may describe a sub-category of those inputs based on a wide range of factors related to whether an agent 108 can or should handle a transaction. It will be appreciated that agent availability 302 may be considered a subcategory of agent capability, or agent capability may be considered a subcategory of agent availability 302, i.e. an agent 108 may not be considered available if he/she does not meet the minimum capability requirements, as will be described and, likewise, an agent 108 is not capable if he/she is not available. For discussion purposes herein, agent availability 302 is considered a sub-category or an input of the agent capability category, but as described, this is implementation dependent.

Agent price 306 is another input or sub-classification/sub-category of inputs/information that may be categorized as an agent capability and refers to the rate or cost of a particular agent. For example, the agent price 306 may refer to the amount that the client 102 must pay for a particular agent 108 to be matched with one of its customers 104. When an agent 108 is matched with a customer 104, the agent price 306 of each agent 108 may be an input that is considered. Depending on the embodiment, the agent price 306 may be an input from the agent 108 to the order distributor 204 or from the service provider 106 to the order distributor 204. In the case of a service provider 106 overseeing the agents 108, the agent price 306 is the amount that the client 102 pays the service provider 106 for a particular agent 108. In that scenario, the agent price 306 is an input from the service provider 106 to the order distributor 204. Alternatively, the agent price 306 is the amount that a service provider 106 pays the agent 108 and the client 102 in turn pays the service provider 106 for the agent 108. Accordingly, the agent price 306 may be an input provided by the agent 108 to the order distributor 204.

The agent price 306 of a particular agent 108 may influence the choice of whether that agent 108 is appropriate for a particular client or customer match. In one embodiment, some agents 108 may be more expensive than other agents based on any of the agent capability factors discussed herein or any additional factors not mentioned. As one example, bilingual agents 108 may have a higher agent price 306 as compared with agents 108 which only speak a single language. Different clients 102 may have different price/quality/capability requirements based on the situation. For example, during the busy lunch hour, a fast-food restaurant client 102 may want to utilize agents 108 that are the quickest at taking and entering orders despite the fact those agents 108 have a higher agent price 306. As will be described below, this may be specified by the client 102 via the client requirements inputs. Likewise, during a down period when the customer flow is low, that same fast food restaurant may want the cheapest, lowest price agents 108 regardless of the other capability considerations.

In one embodiment, agent price 306 is a data value representative of the price charged for the services rendered, as described. In an alternate embodiment, agent price 306 is a derived value or, alternatively, describes a sub-category of inputs related to the price charged for the services rendered, e.g. agent cost and profit margin, from which the charged price may be derived. For example, where the order distributor 204 is operated by a third party service provider 106 as a service to the client 102, the service provider 106 will seek to recoup costs and earn a profit for providing such services. To that end, the service provider 106 will have defined costs associated with the provision of the agent 108, such as salary, benefits, training, equipment, etc. In addition, the service provider 106 will have defined a profit margin they are seeking to earn, which may be fixed or dynamic, such as varying with demand, time of day, rush hour etc. The agent price 306 may be derived from the sum of these values. An additional, “haircut” or bias input may also be included that accounts for factors which negate or add to the amount that can be charged for a given agent 108, i.e. accounts for the agent's 108 value, such as the agent's 108 ability level, experience, etc. This haircut input may be factored into the derivation of the agent price 306 to increase or reduce the price charged to an amount in line with the agent's 108 overall value.

In one embodiment, the capability of agents 108 may be ranked with labels such as gold, silver, or bronze to signify different levels of price or abilities. The labels may be an overall ranking or agents 108 may be ranked in different categories. Accordingly, the labels may also correspond to the price of an agent, where a gold agent 108 has the highest price and a bronze agent has the lowest price. The ranking may establish different prices based on the ability level of an agent. A client 102 can elect to pay a higher price for gold agents when very busy, but only use bronze agents when the client 102 is not as busy. Some clients 102 may only want to use gold agents despite the high price as an attempt to be more efficient and improve customer service.

In alternate embodiments, the agents 108 may not be ranked as discussed above, but rather each agent 108 has his/her own price that is based on various other factors or inputs within the sub-category described as the agent price 306. The factors may be those categorized as an agent capability, or may include any additional inputs or factors. These factors may include both objective and subjective factors. Subjective factors may be evaluated based on a manager's review, such as the friendliness factor, whereas objective factors, such as the processing time of each order or other metric, may be objectively measured and do not require subjective interpretation. Accordingly, agents 108 scoring high across one or more factors may have a higher price as compared to lower scoring agents. For example, a client 102 may select an agent 108 with excellent customer service but that is average in other categories because that agent 108 has a lower price, but provides the client 102 with a given characteristic that the client 102 values more than the others.

Another input categorized as an agent capability is profit margin 308. Profit margin 308 relates the profit that the order distributor 204 realizes for each match of an agent 108 and customer 104. As described above, profit margin 308 may be an input described under the agent price 306 category and factored into the price charged for an agent 108 but also may be considered a separate input value or sub-category of values dependent upon the implementation. If the service provider 106 is independent of the client 102, then the profit margin 306 may refer to the profits from each match made by the service provider 106, independent of the a price charged by the agents 108. Likewise, if the service provider 106 encompasses the agents 108, then the profit margin may refer to the profits made by the service provider 106 or agents 108 for each match of the order distributor 204. Accordingly, the service provider 106 provides a profit margin input to the order distributor 204. Alternatively, if the service provider 106 is a part of the client 102, then the profit margin may refer to the profits that the client 102 receives for each match and the client 102 provides the profit margin input to the order distributor. The profit margin 308 is a measure of the profit made from each of the order distributor's 204 matches. The order distributor 204 may match agents 108 with customers to achieve a higher profit margin for the service provider 106. Alternatively, the order distributor 204 may utilize the profit margin 308 input to reduce costs to the client 102.

The profit margin 308 may be dependent on the agent price 306 that a client 102 is paying for each transaction with an agent 108 and all the costs that are associated with that agent 108 for the transaction. Profit margin 308 may be determined based on the agent price 306 that a client 102 will pay for a particular agent 108 minus all the costs associated with that agent 108 including the agent's rate of pay. The higher the price and the lower the costs, the more valuable an agent is, as was described above. Profit margin 308 may be viewed as the value of each agent 108 to the service provider 106. Other factors or considerations may influence the profit margin 308. For example, a new agent 108 that has ranked/scored very well and is considered to be a high quality agent, but has a low pay rate because of lack of experience may have a very high profit margin 308 and be considered a very valuable agent 108 for the service provider 106 (but conversely, of low value to the client due to inexperience). As discussed below, agents 108 may be ranked or scored based on performance in a variety of areas, such as the inputs associated with the quality 310. An agent 108 with a lot of experience, but who is ranked or scored as a low quality agent may have a very low profit margin 308 because the experience may give the agent a high pay rate or cost, but the low quality rating may result in clients 102 only wanting to pay a minimum price for that agent, i.e. the client value is minimal.

Another input categorized as an agent capability is an agent's experience 304. The agent's experience 304 may be an input that is considered by the order distributor 204 when a client 102 defines a particular set of agents 108 that they are interested in. For example, a client 102 may want an agent 108 who has at least a minimum amount of experience or who has taken a minimum number of orders for its store. Agent experience 304 may be an input provided by the agent 108 to the order distributor 204, or provided by the service provider 106 to the order distributor 204. Agent experience 304 may encompass any past or present knowledge that an agent 108 has had that may be helpful in completing a transaction. Past jobs or other resume experiences that occurred prior to working as an agent 108 may be relevant as well as any job training and real-time job experience.

Agent experience 304 may be one of the factors considered in determining the rate or agent price 306. For example, after two years of experience, a bronze agent may be upgraded to a silver agent assuming that other capability/quality factors merit the upgrade. In an alternate embodiment, agent experience 304 may be derived from other inputs or describe a further sub-category of inputs, such as past experience, present experience, or utilization level. These inputs from the sub-category of experience will be discussed below.

The past experience input may reflect experience that an agent 108 had before becoming an agent 108 and may be a factor in an agent's capability. For example, if an agent 108 was an employee at a fast food restaurant taking orders before becoming an order-taking agent 108, that experience may be beneficial to the agent 108.

The present experience input may reflect any time and effort made as an agent 108 in their current position, i.e. their present on-the-job experience. This job experience may include off-line training as well as real-time on-the-job learning. The time a particular agent 108 has been handling transactions may be considered on-the-job training. Generally, the more experience an agent 108 has handling transactions and dealing with customers 104, the more efficient that agent 108 will be. In addition to the learning or experience that may take place while working as an agent 108, there may be a training program for agents 108. The training may be for preparing an agent 108 to begin work, or there may be periodic training sessions to refresh agents. Each agent 108 may need to be trained for different clients 102 from which they handle transactions. For example, for a fast food restaurant client 102 there may be training to learn and become familiar with the menu of that restaurant.

The utilization level input reflects an agent's 108 utilization as a function of their availability, whether controlled by the agent 108 themselves or as a matter of circumstance, i.e. there is insufficient work load to keep the agent 108 100% utilized. For example, an agent 108 may select the level at which they want to be utilized, reflecting the agent's 108 desired workload. For example, an agent 108 may request to be utilized at an 80% level, meaning that agent 108 may be on a call 80% of the time. Accordingly, an agent 108 only requesting 50% utilization will be used less than an agent 108 requesting 80% utilization, assuming all other factors are equal. Alternatively, there may only be sufficient workload to keep a particular agent utilized 80% of their available time.

The actual utilization may be a separate input from the requested utilization. For example, the agent's requested utilization may be ignored, e.g. even though an agent 108 requests 50% utilization, the actual utilization may be 80% if there is a high demand for agents. The actual utilization may depend on the desired utilization of the system or the service provider 106. Allowing agents 108 to request utilization levels improves the flexibility of the agents' jobs. For example, if an agent 108 is not feeling well, he/she may wish to handle fewer orders and therefore, he/she requests a lower utilization level. Conversely, if an agent 108 wants to handle many orders, he/she may request increased utilization. However, the requested utilization may be different from the actual utilization. Actual utilization may be considered a part of experience because the actual utilization of an agent 108 contributes to the agent's experience. In other words, the more an agent 108 is utilized the more experience that agent 108 will have.

Another input categorized as an agent capability is an agent's quality 310. The agent quality 310 may be a relevant factor in the matching of an agent 108 with a customer 104. Agent quality 310 relates to the general abilities of an agent 108 to meet particular standards set by the service provider 106, the client 102, etc., and may be subjectively and/or objectively determined. In particular, agent quality 310 may be reflective of the results of comparing various metrics of the agent's abilities against associated standards. A client 102 may look at a number of qualities that an agent 108 possesses in making a selection of an agent. Agent quality 310 may be any attribute that an agent 108 possesses that may be considered by a client. In one embodiment, agent quality 310 may be an input that represents an overall quality value for an agent. Alternatively, the agent quality 310 input may be a value derived from other inputs or may describe a sub-category of inputs, which relate to the quality of the agent 108.

In an alternate embodiment, agent's quality 310 may describe a sub-category of agent capability 302 that includes various inputs that are relevant to the quality of an agent 108. Further, the agent quality 310 sub-category may be divided into additional sub-categories such as objective considerations and subjective considerations, used herein for discussion purposes. The inputs in either sub-category may be categorized differently depending on the implementation.

Agent quality 310 may be evaluated based on a quality score or rank that includes the objective and/or subjective data relating to the agent's performance. The score or rank may be representative of overall quality of an agent. Alternatively, the score or rank may be derived from inputs related to agent quality 310. Each agent 108 may be evaluated based on any of the other inputs listed herein or other inputs that are not included. The agent's score may influence the price that the agent 108 costs a service provider 106 as well as influencing which agents are selected. The evaluation may be based on an objective comparison with other agents over inputs such as speed or time per order. Likewise, the evaluation may be subjectively based on a manager's analysis of the agents' performance for inputs such as customer service. The scoring or ranking of agents 108 may influence their selection by clients 102 and the amount that the agent 108 costs a client 102.

The inputs from the quality sub-category may be provided by the agent 108, the service provider 106, or combinations thereof. Any of the quality considerations may be recorded by the service provider 106 or the agents 108 themselves. In one embodiment, there may be a database, not shown, that stores all of the inputs discussed herein and each agents' score/rank/value for that particular input. Accordingly, when a client 102 would like to utilize an agent 108 with certain qualities, the client 102 or service provider 106 may retrieve the qualities for each agent 108 from the database to compare agents 108 and select the most appropriate agent 108.

As discussed above, the sub-category of quality 310 may be further sub-divided into objective or subjective sub-categories. Subjective qualities are those that are based on opinion, whereas objective qualities are measured based on objective information, observations and/or measurements. Examples of objective elements, as discussed below, are reported incidents, accuracy, selling process, technical issues, speed, revenue generated, reliability, language ability, familiarity, and available software. These objective inputs will be discussed below.

The number of reported incidents or problems an agent 108 is involved with may influence that agent's selection by a client. In one embodiment, the number of reported incidents is a value describing the number of customer 104 complaints or problems a particular agent 108 has had. In particular, this input is relevant for an agent 108 who has a high number of customer complaints or displays an inability to properly handle difficult customer situations. Potential examples of reported incidents may be rudeness, negligence, incompetence, or a premature disconnection from the customer. These incidents may be reported as customer complaints against an agent 108. All agents 108 may have reported incidents from unhappy customers 104, but a comparatively large number of incidents may be an indication of a more serious customer service problem. In one embodiment, each reported incident may be reviewed by a manager for quality control purposes. The manager may then determine whether the agent 108 was at fault for the incident or whether the agent 108 handled the situation properly. An agent 108 should not be blamed for a reported incident that was handled professionally. Accordingly, the incident may only affect the agent's 108 rank if it is determined the agent 108 did not handle the situation properly. The number of reported incidents may be recorded by the service provider 106 or by the agents 108 themselves.

Accuracy is another input from the objective quality sub-category of the agent quality 310 sub-category. In one embodiment, accuracy is a data value describing whether an agent 108 properly handles transactions and/or orders without mistakes. Accuracy may be a measure of the ability of an agent 108 to accurately receive and complete a transaction or order for a client 102. In one embodiment, accuracy may be measured based on incorrect orders that are reported by a customer 104 or by the client 102, detected during supervisory monitoring of a given transaction. For example, if an agent 108 incorrectly enters a large drink rather than a medium drink, and the customer 104 informs the client 102 of the error, then the error may be included in the agent's measured accuracy. Additional examples of order accuracy issues may be an incorrect item, wrong quantity, missed item, improper order preparation, failure to report entire order, premature disconnection from customer, selling of an unavailable item, giving a wrong order total, failing to clarify the order, improper charge for an item, incorrect product information, exceeded product limit, or wrong coupons. There may be many other examples of potential accuracy issues. Any instance of an agent 108 incorrectly completing a transaction, or a customer 104 not receiving the proper order because of an agent 108 mistake may result in a reduction of the accuracy value for that particular agent 108.

As with any of the inputs, the measurement of individual factors may be based at least in part on a manager's review of customer-agent interactions. In one embodiment, a manager may, at a minimum, review transactions for which a complaint or error occurred to determine whether the agent 108 was at fault. This review allows for a more truthful characterization of an agent's 108 performance for any of the factors. For example, a customer 104 may complain about a mistake in an order, but if it turns out that the customer asked for the wrong item, then the agent 108 should not be blamed for the alleged mistake.

The selling process is another input under the objective consideration sub-category from the agent quality 310 sub-category. Selling process may be a data value representative of whether an agent 108 follows the client's 102 established procedures. Selling process may be a description of the correct procedure that an agent 108 is to use for any given client 102. The selling process may vary with each client 102. For example, some clients 102, such as fast food restaurants may want an agent 108 to cross-sell and/or up-sell, e.g. suggest additional or more expensive items, while other clients 102 may want quicker turnaround and forego cross-selling and/or up-selling. The selling process may refer to any procedures that an agent 108 is to follow for a particular client 102. A failure by an agent 108 to properly follow the defined selling process may identify agents 108 that are not as capable for certain clients 102 or transactions. The selling process may include additional factors such as a time limit for each transaction, suggesting proper items, properly entering the transaction, failing to suggest an alternative for an unavailable item, or any other procedure or protocol that an agent 108 should follow.

An additional objective consideration input is an agent's 108 ability and success utilizing the necessary technology for connecting with or communicating with customers. The technical issues that an agent 108 encounters may be a data value representative of whether a particular agent 108 has technical problems or difficulties. An agent 108 that frequently experiences technical issues may not be as valuable because they are unreliable. For example, technical issues may include poor audio quality, dropped calls, or other software or hardware issues during a communication with a customer 104. Regardless of whether a technical issue is the fault of an agent 108, the service provider 106 may consider whether a particular agent 108 has a history of technical issues in matching with a customer 104.

Another objective consideration input is speed. Speed may be a data value representative of the rate at which an agent 108 receives, processes, and completes a transaction or order. The speed of agents 108 may be an important input used in the service provider's 106 selection of a particular agent 108. Certain clients 102 may have a set time limit in which each transaction should occur. Conversely, other clients 102 may actually encourage agents 108 to chat with the customers 104 and may not value prompt transactions. Speed may be measured in a variety of ways including an average, minimum and/or maximum talk time, response time, number of calls over a defined period, or combinations thereof.

Another objective consideration input is the revenue generated by the agent 108. Generated revenue may be a data value representative of the total revenue generated by an agent 108 and/or the extra revenue that an agent 108 generates based on selling additional or more expensive products. Certain clients 102 may request that agents 108 suggest items to a customer 104 during a transaction. For example, a fast food restaurant may want customers 104 to try its new burger, so the agent 108 may be required to ask each customer 104 if they would like to try the new burger. An agent's 108 success rate of influencing a customer 104 to order the new burger may be a measurement of an agent's quality. Accordingly, the extra revenue generated based on an agent's 108 suggestions may be a factor in matching an agent 108 for a client. Likewise, the size/total revenue of a transaction for an agent 108 may also be measured. A client 102 may want agents 108 to operate as sales associates and attempt to sell additional products to a customer 104 to maximize the value of each transaction. Agents 108 that are able to successfully convince customers to order additional products may be more valuable to certain clients 102. The revenue generated per order may be a measure of the selling techniques for a particular agent 108. Revenue generated may also be referred to as the upsell success of an agent 108. This input may need to be balanced against the customer service or friendliness inputs because an agent 108 that is very pushy may be viewed negatively by customers 104. The client 102 may have to balance whether it is more important to include agents 108 that generate high revenue per-order, or agents 108 that customers 104 feel are very friendly. Clients 102 may have the flexibility to select the agents 108 that best fit their needs.

Another objective consideration input is reliability. Reliability may be a data value representative of whether an agent 108 is reliable. The reliability of an agent 108 may be important to a client 102. Reliability may include whether an agent 108 consistently performs to the standards set by the store. Alternatively, reliability may be related to many of the other inputs. As discussed above, an agent 108 that has frequent technical issues with their network connection may not be reliable. Conversely, an agent 108 with few reported incidents of problems may be viewed as very reliable. Accordingly, in alternate embodiments, reliability may be a derived value, derived from other inputs or additional inputs not discussed herein.

Another objective consideration input is the language/dialect abilities of an agent 108. The language/dialect may be a data value representative of the language(s) or dialect(s) that an agent 108 speaks or has. A client's 102 customers 104 may speak different languages or have specific dialects that the client 102 will want an agent 108 to match. Accordingly, an agent 108 that speaks the customer's 104 language or has a similar dialect may be chosen for certain customers 104. For example, if a customer 104 only speaks Spanish, then a Spanish speaking agent 108 should be chosen. Likewise, for a client 102 located in the South, agents 108 may be chosen that have a Southern accent. Accordingly, agents 108 that are bilingual or multilingual may be more valuable because they can handle transactions with customers 104 that do not speak English.

Another objective consideration input is familiarity. Familiarity may be a data value representative of an agent's 108 acquaintance with a given transaction/order type, client 102 or customer 104. An agent's familiarity with a particular client 102 or transaction may improve the agent's overall performance. This may be related to an agent's experience 304. For example, if an agent 108 has taken numerous orders from a particular fast food restaurant, then that agent 108 may be more effective than an agent 108 who has not taken many orders from that restaurant. Familiarity with a menu, products or order items may allow for a smoother transaction. A client 102 may desire agents 108 that have greater experience or familiarity with their store or products. Increased familiarity may improve many of the other quality considerations, such as speed, accuracy, or reported incidents.

Another objective consideration input is the software or information that is available to an agent 108. In one embodiment, the available information may be a data value representative of the access that an agent 108 has to relevant information needed to handle a particular transaction or order. The available information may be related to the familiarity factor because it is a consideration of whether an agent 108 possesses a particular client's information. In an alternate embodiment, the available information may be a derived value based on other inputs, such as the familiarity input, described above. For example, each client 102 may provide an inventory or a menu to the agents 108, so that the agent 108 can access that information in handling a transaction. If a particular agent 108 already has all the relevant data/software, then that agent 108 may be selected over an agent 108 for whom new data/software must be provided. It may take time to transmit, upload or otherwise provide the appropriate software to another agent, so the client 102 may select an agent 108 with the up-to-date data/software to save time. The data/software that an agent 108 may need includes inventory, menus, coupons, promotions, specials, and any additional information that may be relevant for the agent 108 to handle a transaction, including information from any other considerations or factors.

As discussed above, the agent quality 310 sub-category may further include subjective considerations. The subjective considerations sub-category may include inputs that are determined or measured based on opinions, estimates, judgments, impressions, etc. For example, a managerial evaluation of an agent's performance is a subjective measurement. There is no right or wrong way to measure, but rather a decision is made based on a subjective opinion. Exemplary subjective consideration inputs, as discussed below, include friendliness and customer service.

One subjective consideration input is friendliness. In one embodiment, friendliness may be a data value representative of the perceived friendliness of an agent 108. Friendliness is a subjective input that, in one embodiment, may be measured through a manager's review of an agent's interactions with customers. Alternatively, friendliness may be measured through customer feedback, such as a customer survey or comment card. Friendliness may include a wide variety of sub-factors, such as greeting, tone, or attentiveness. An agent 108 who is rude, inconsistent, insincere, robotic/mechanical, unhelpful, or discourteous may be considered to be unfriendly. Some clients 102 may want agents 108 to always greet the customer 104 and may encourage “small talk” with the customer 104. Other clients 102 may want orders to be received and entered as quickly as possible and thus discourage unnecessary conversation. The order distributor 204 may use a subjective measurement of an agent's friendliness when matching the agent 108 with a particular client 102 or customer 104.

Another subjective consideration input is customer service. In one embodiment, customer service may be a data value representative of an agent's 108 ability to serve the customer. In an alternate embodiment, customer service may be a derived value based on additional inputs. For example, customer service may be related to or include the friendliness input discussed above. Examples of customer service considerations may include prompt greeting, friendly greeting, no interruptions of the customer, not speaking too fast, correct information given, articulating words, thanking the customer, clarifying a customer's order, proper phrasing, not being repetitive, and not disconnecting too soon. Further, the handling of unusual customer requests or questions may also be representative of good customer service. Customer service may include anything related to customer satisfaction. In one embodiment, customers may be surveyed regarding their experience with any particular agent 108. The subjective results from the customer survey may be included in a customer service score for the agent 108 and the score represents the input for customer service.

In addition to the category of agent capability, inputs may also be generally classified as a client requirement. Client requirements may include information relating to the requirements that the client 102 may establish for the selection of an agent 108. The requirements may include any of the inputs/considerations discussed above under the agent capabilities category. Additional categories of requirements are shown in FIG. 3. In particular, the client requirements category may include sub-categories of inputs, such as: client information 312, price 314, customer information 316, and reliability 318. The requirements may be broken into further sub-categories of static considerations and dynamic considerations as discussed below. Static considerations are those requirements that do not fluctuate over a certain period of time, whereas dynamic considerations may fluctuate over a period of time that is shorter than the time period defined for static considerations. Client information 312 may be a sub-category of the static consideration sub-category, while price 314, customer information 316, and reliability 318 are sub-categories of the dynamic considerations sub-category as discussed below.

Static considerations may be those requirements that do not readily fluctuate over a defined period of time. In one embodiment, static considerations include those considerations that generally do not vary over a single day, for example. As discussed below, static considerations may include inputs categorized as client information 312. The static considerations may further be categorized based on the length of time the information is, or is expected to remain, static. For example, client information 312 may further include constant client information, which rarely changes for a particular client, and variable client information, which is more likely to change than constant client information, e.g. the information remains static throughout a day, but may change from day to day. Inputs categorized as constant client information and variable client information will be discussed below.

Constant client information may include inputs such as the client type and location. In one embodiment, constant client information may be a derived value, or may describe a sub-category of inputs related to client information, such as client type and location. Client type may refer to the type of client or the type of products that are sold by the client. Client type may be a data value representative of the type of business or products that a particular client 102 has. For example, a fast food restaurant will remain a fast food restaurant tomorrow and does not change from day to day. Accordingly, the client type is a restaurant or fast-food restaurant.

Likewise, the location of a client 102 usually does not change, so the location is considered constant client information. The location may be a data value representative of the geographic location of a client 102. The location of a client 102 may be a relevant factor in the matching of an agent 108 for the client. For example, a store located in the South may request an agent 108 with a Southern accent. A store located in a particular time zone may request agents 108 also located in that time zone.

In addition to constant client information, static considerations further include variable client information. Variable client information inputs may include inputs of client information that fluctuates more often than constant client information inputs, e.g. from day-to-day. In one embodiment, variable client information may include inputs such as the number of workers currently working, the number of workers on a break, the coupons/specials/promotions, or the client priority. The variable client information may be consistent throughout a day or at least may be known or controllable at the client 102 level as opposed to the dynamic considerations, discussed below, which may vary hour-by-hour, or minute-by-minute, i.e. subsequent inputs are never presumed to be the same.

The number of workers that are present at or working for a particular client 102 may influence the matching of an agent 108 with a customer 104 of that client 102. In one embodiment, the number of workers may be a data value representative of the number of current workers, or the number of workers at any give time. The number of workers may be relevant because if a client 102 is short-staffed, it may rely heavily on agents 108 to handle transactions. Conversely, if a client 102 has plenty of employees, the client 102 may elect not to use agents 108 as frequently, or may not be willing to pay as much for agents 108 to handle transactions. Likewise, the number of workers may vary throughout the day as workers take breaks, as well as start and end shifts. The workers on a break may be a data value that is an input. As one example, if a number of workers are on a lunch break, a client 102 may require more agents 108 to handle transactions. Generally, the number of workers and the number of workers on break are inputs that fall under the static considerations sub-category because they may be under the control of the client. In other words, the client 102 is generally aware of how many workers will be present at any given time, so the client 102 may plan accordingly.

The promotions, coupons, or specials that a client 102 may offer may be considerations that the service provider 106 utilizes in matching agents 108. In one embodiment, the promotions, coupons, or specials may be a data value representative of the current or future promotions, coupons, or specials. An example of a promotion may include a client's desire to sell a certain number of a particular product. For example, if a new product was launched, the client 102 may try to sell that product to raise awareness. Coupons may be any discounts or rebates on particular products. Specials may be any programs or other discounts a store is running. For example, on Mother's Day, a client 102 may give Mothers a 10% discount. The promotion, coupon, or special information of a client 102 may be relevant in the matching of agents 108 with customers 104. The utilization of agents 108 may need to be increased depending on the promotion, coupon, or specials for a client. Further, if the promotion, coupon, or specials information is already known by a particular agent, then that agent 108 may be a more effective match for the client 102.

The order distributor 204 may consider the priority of particular clients 102 in selecting and matching agents. In one embodiment, client or store priority may be a data value representative of a ranking based on the priority of service for particular clients 102. For example, clients 102 may be given the option of paying an increased rate for preferred service from the order distributor 204 or service provider 106. Similar to agent classification, clients 102 may be classified as gold, silver, and bronze. The gold clients may receive priority agents 108 and priority scheduling in return for an increase in the charges that the client 102 pays to the service provider 106 or agents 108. Conversely, the bronze clients may have lower priority service, but may also pay less for the use of agents. The prioritization of clients may be used not only based on pay rates, but also a new client 102 may be given gold priority for a trial period to encourage that client 102 to utilize the system and agents 108. Likewise, if a particular client experiences a problem or difficulty with the service provider 106 or any agents 108, then that client 102 may be moved to gold priority to keep the client 102 happy with the service provider 106.

As discussed above, client requirements is a category of inputs into the order distributor 204 and may be sub-divided into static considerations, discussed above, and dynamic considerations. Dynamic considerations includes inputs whose requirements tend, or are assumed to fluctuate over a certain period of time, whereas static considerations may, or are assumed, not fluctuate over a short period of time. In one embodiment, the inputs in the dynamic considerations sub-category may vary throughout a single day, or may even vary minute-by-minute or transaction-by-transaction. Alternatively, dynamic considerations may include those inputs over which the store does not have complete control or cannot predict. As shown in FIG. 3, dynamic considerations may include further sub-categories such as the price 314 a client is willing to pay for an agent, customer information 316, and reliability 318. Each of these sub-categories is discussed below.

The price 314 a client 102 is willing to pay for an agent 108 is a dynamic consideration because a client 102 may be willing to pay a different price for an agent 108 at different times throughout a day. The price that a client 102 is willing to pay for an agent 108 may be influenced by the agent capabilities, agent demand, etc. as discussed above. The price that a client 102 is willing to pay may be directly dependent on the capability requirements that a client 102 establishes at any given time for an agent. For example, a fast food restaurant may only request the fastest agents 108 during the lunch hour even though they cost more per order than slower agents 108. Likewise, a client 102 may want to pay more for a bi-lingual agent 108 to ensure that its customers are able to communicate with the agent 108. Accordingly, any of the agent capability inputs discussed above, or any other factors or inputs may influence the price and/or matching of any particular agent 108.

The price 314 that a client 102 is willing to pay for an agent 108 may be further influenced by the queue status. The queue status is a dynamic consideration because it may change frequently and is not under the control of the store. In one embodiment, queue status may be a data value representative of any queue information related to the number of customers 104 waiting to complete a transaction or an order. In an alternative embodiment, queue status may be a derived value based on other inputs or, alternatively, describe a sub-category of inputs related to queue information, such as number of queues and the maximum, minimum or average queue length, wait time, and/or capacity.

Queue length may be a data value representative of the length of the queue and may be provided for each operating or available queue in the restaurant. The queue length may be the current queue length or the predicted queue length for each available/operating queue. For example, in a fast food restaurant, the queue length may be the number of cars in the drive-through lane. The longer the queue, the greater the demand for any given product is likely to be thereby increasing the need for an agent. Accordingly, when a client's queue length increases, the service provider 106 and/or agents 108 may be notified that they may be asked to share the burden of handling transactions to reduce the queue. In one embodiment, the queue length may be an input that is representative of the backlog at any given time.

The wait time may be a data value representative of the length of time that a customer 104 must wait before placing an order or completing a transaction. In an alternate embodiment, the wait time may be a derived value that is dependent on the queue length or other queue status information. The wait time may be computed based on the previous average wait time per customer multiplied by the queue length. For example, if the average wait time for a drive-through restaurant is 30 seconds for each drive-through order and the queue length is five cars, then the wait time for the fifth car is two minutes because each of the four cars in front of the fifth car takes an average of 30 seconds.

Wait time may include a current wait time based on the current queue length or may include historic wait time based on other inputs or historical data related to the queue. Accordingly, the wait time input may be a derived value based on other inputs or historical data. Historical data may include past wait time or queue status information based on the conditions at the time. For example, the historical data may suggest that a given holiday results in increased queue length. Accordingly, the order distributor 204 may utilize historical data in estimating future queue status information, such as queue length or wait time.

The capacity may be a data value representative of the number or amount of customers that a client 102 or particular queue can handle at a given time. In an alternate embodiment, the capacity may be a derived value that is dependent on the queue status or related inputs. Capacity may include the maximum queue length. If a store or client 102 can only accommodate ten customers in a queue, then the store may need to take action to reduce the queue length if it approaches the capacity.

The inputs of queue length and wait time may be influenced by a number of factors. For example, the time of day, the day of the week, the season, the weather, or local events may all cause transaction demand to fluctuate. Accordingly, there may be an input for the predicted queue length and predicted wait time that are determined based at least in part on these factors. Accordingly, each of these factors may also be an input that is relevant to the queue status. Clients 102 may experience greater demand and greater queue length at different times of day. For example, a fast food restaurant knows that the queue is likely to be the longest during rush hours or during the breakfast, lunch and dinner hours. Likewise, a retail store may receive a greater number of calls or orders on weekday evenings after working hours. As with the time of day, the day of the week may influence customer demand and queue length. Certain clients 102 may be busier on the weekend when customers are not at work. Some clients 102 are busiest during the summer months when kids are not in school.

The weather may affect the queue length of a client. Severe weather may deter customers from utilizing a particular client 102 if travel is necessary. Accordingly, the queue at a drive-through lane at a fast food restaurant may be minimal during a snow storm. The order distributor 204 may monitor the weather for any given store and know that in certain weather conditions the demand will drop significantly. Likewise, during a very hot day, the order distributor 204 may know that the sale of ice cream products at a restaurant may increase. The order distributor 204 may be linked with a third party, such as a web site that provides weather information as an input. Accordingly, the order distributor 204 may estimate product demand in order to find and match agents 108 with a client.

A local event in a city may result in increased demand for a client. Any event, such as sporting events, high school events, graduation day, concerts, a fair, farmer's market, town death, harvesting schedule, calving season, or hunting season may result in increased demand. For example, a fast food restaurant outside of a high school football stadium may have a very large demand when a game is over. Many people from the game may go to the restaurant resulting in greater queue length and an increased need for agents 108 to receive orders for the customers. Accordingly, the order distributor 204 may receive local event information as an input so that it may forecast fluctuations in product demand.

In an alternative embodiment, the queue status, and related inputs such as queue length, wait time, and capacity may be further categorized as inputs related to product demand. In one embodiment, product demand may be a data value representative of the demand of a product or products. Alternatively, product demand may be an input that is a derived value based on the queue status, and related inputs. During the lunch rush hour at a fast food restaurant, the price for an agent 108 may be at a premium because product demand is at a peak. However, late at night when there are fewer customers, and product demand may be low, the restaurant may want to pay significantly less for each transaction or agent. Specifically, as product demand increases, the need for an agent 108 also increases. Accordingly, the price that a client 102 will pay for an agent 108 will likely increase with the increased need.

Inventory information may be an additional input related to the price a client 102 is willing to pay for an agent 108 or the product demand. Accordingly, inventory information may be a data value representative of the inventory of a store or client 102. The agent 108 may need to be aware of the quantity of products and their immediate availability. If an item is unavailable or not ready for sale, the agent 108 may suggest alternatives or inform the customer 104 when the product is available. Accordingly, the service provider 106 may supply the agent 108 with the proper information upon matching the agent 108 with a customer. The inventory information may include the quantity of a particular product and/or the production queue for a particular product. Accordingly, in one embodiment, inventory information may be an input into the order distributor 204.

In an alternate embodiment, the inventory information may include additional inputs, such as the inventory quantity and the production queue. The quantity of an item in inventory may be included in the information transmitted to the agent. If an item has a limited quantity, the client 102 may request that an agent 108 discourage customers 104 from ordering that item or suggest alternative items. Likewise, an agent 108 may be encouraged to sell items with very large inventories. The production queue is an alternate measure for inventory of a product that may be an input. The production queue may suggest that a particular product has a back-log, is in production, and/or may not be immediately available. One example would be a fast food restaurant in which french fries are not readily available because they are being cooked. The agent 108 may inform the customer 104 that french fries will not be available for several minutes.

Accordingly, the need for an agent 108 influences the price that a client 102 is willing to pay for an agent 108. High product demand may result in increased queue length and wait time, which may increase the price that a client 102 will pay for an agent 108. As discussed above, the first sub-category for dynamic considerations is the price 314 a client 102 is willing to pay for an agent 108.

Customer information 316 may influence the matching of an agent 108 with a client 102 based on the needs of the client's 102 customer 104. In one embodiment, customer information 316 may be a data value representative of certain customer information, such as linguistic ability, amount of time in queue, etc. Alternatively, customer information 316 may be a derived value or be a subcategory including inputs related to information on the customers 104. For example, if a customer 104 speaks a language other than a language generally spoken by the collective agents 108, then he/she may need to be matched with an agent 108 having the specific ability to speak the language of the customer 104, e.g. Spanish speaking customer 104 may be matched with a Spanish speaking agent 108. Additionally, the dialect of a customer 104 may also be matched through an agent 108. In one embodiment, the dialect of a customer 104 may be automatically determined, such as via voice recognition, and an agent 108 with a similar dialect may be connected with the customer 104. For example, a customer 104 with a Southern accent may be matched with an agent 108 having a Southern accent. This may be implemented regardless of the location of the store. For example, a customer 104 with a Southern accent at a Chicago store may still prefer having an agent 108 with a Southern accent. Likewise, customer information may further include any additional customer requests. For example, a customer 104 with hearing problems may be matched with an agent 108 whose call or connection is configured to be extra loud enabling the customer 104 to hear the agent.

Dynamic considerations further include inputs relating to network or power reliability 318. In one embodiment, the network or power reliability 318 may be an input into the order distributor 204 that is reflective of the reliability or consistency of a particular agent's 108 network or power source. The connection of the client 102 with the order distributor 204 and/or with an agent 108 may be a consideration used by the service provider 106 in matching agents 108 and customers 104. If the network connection of the client 102 is inconsistent, it may be necessary to only select agents 108 with very strong network signals to ensure a quality connection.

The inputs/requirements discussed above, or derivations thereof, may be provided to the order distributor 204 to be used in the agent 108 selection process. It will be appreciate that there may be additional or fewer inputs into the order distributor 204 and that these inputs may be categorized or originate from a different source than described in the embodiments above. The matching may be designed to select an agent 108 that best meets the client's 102 needs. As discussed below, the inputs that are used in the selection will generally be referred to as properties.

FIG. 4 is a block diagram of an order distributor system 400, according to one embodiment, that analyzes the inputs, properties and/or factors discussed above, in order to select an optimal agent 108 based on those inputs/properties. In particular, the system 400 implements a process for analyzing agents 108, clients 102/stores 402, customers 104, and other data to determine which agent 108 should be matched with a particular customer 104. It will be appreciated that there may be other implementations which achieve the disclosed functionality for selecting an optimal agent 108.

The system 400 includes an order distributor 204, having a receiver 206, processor 208 and selector 210, as described, for receiving a signal, order request or customer presence indication and matching of an agent 108 with a customer 104 in response thereto as discussed above. In the embodiment of FIG. 4, the optimal agent 108 for a call or order is selected for a particular customer 104 based on comparisons/evaluations of relevant data, such as the inputs/properties discussed above or subset thereof, against, a mandatory property set and, optionally, an optional property set. In one embodiment, a mandatory property set may be a subset of client requirements that the optimal agent 108 must meet and the optional property set may be client requirements that an agent 108 does not have to meet but that may identify the agent 108 that is optimal. Accordingly, the optimal agent 108 may be selected so as to satisfy, in whole or in part, the set of predefined mandatory properties, or defined subset thereof, such as by determining that the inputs related to the capabilities of a given agent 108 substantially meet the inputs related to the client requirements of the client 102. Additionally, there may be predefined optional properties that are also considered in selecting an agent 108. If an agent 108 is not found who satisfies the mandatory properties, the transaction may be dropped and the client/store 102 may then handle the customer transaction or order internally, without an agent 108. Alternatively, the system 400 may make one or more subsequent attempts to select an agent 108 after a defined waiting period. The defined waiting period may be fixed, random or based on an analysis of agent availability.

Generally, the disclosed embodiments select an agent 108 in a quick and flexible manner in response to an order request, i.e. an indication that a customer is present and waiting. In one embodiment, the order distributor 204 may analyze available agents 108 and select an appropriate agent 108 in about 20 milliseconds or less. Depending on the implementation, the maximum time may vary. The decision making process of the disclosed embodiments is modifiable, so that an agent 108 may be selected for a particular client 102, store 402 or service provider 106 based on properties that are tailored to that entity.

The receiver 206 of the order distributor 204 receives the inputs of properties, including any of the inputs/properties discussed above, from a variety of sources such as the service provider 106, store 402, client 102, outside service 404, database 406 and/or agent 108. The order distributor 204 further includes one or more difference processors 416 coupled with the receiver 206, one or more remapping processors 418 coupled with the difference processors 416, one or more weighting processors 420 coupled with the remapping processors 418 and a selector 210 coupled with the weighting processors 420. In one embodiment, the difference processor 416, remapping processor 418, and weighting processor 420 may be part of a single processor 208. The input data includes client requirements and/or corresponding agent capabilities, shown as P₁ 412₁₋ₙ and P₂ 414₁₋ₙ , which are processed and compared as will be described. The processing of the properties includes differentiating 416, remapping 418, and weighting 420 the properties to derive a score/rank that is input into selector 210 as discussed below. The system 400 may further include a remapping database 419 and a weighting database 421 wherein the remapping processor 418 may retrieve from, and/or store data in, the remapping database 419 and the weighting processor 420 may retrieve data from, and/or store data in, the weighting database 421. The selector 210 selects an appropriate agent 108 based on the property comparison and the resulting scores. In one embodiment, once a selection is made, the selector 210 communicates the relevant data, such as the order request, to the selected agent 108 to that the selected agent 108 may handle the transaction, i.e. initiate the connection to the customer or, alternatively, receive a connection from the customer.

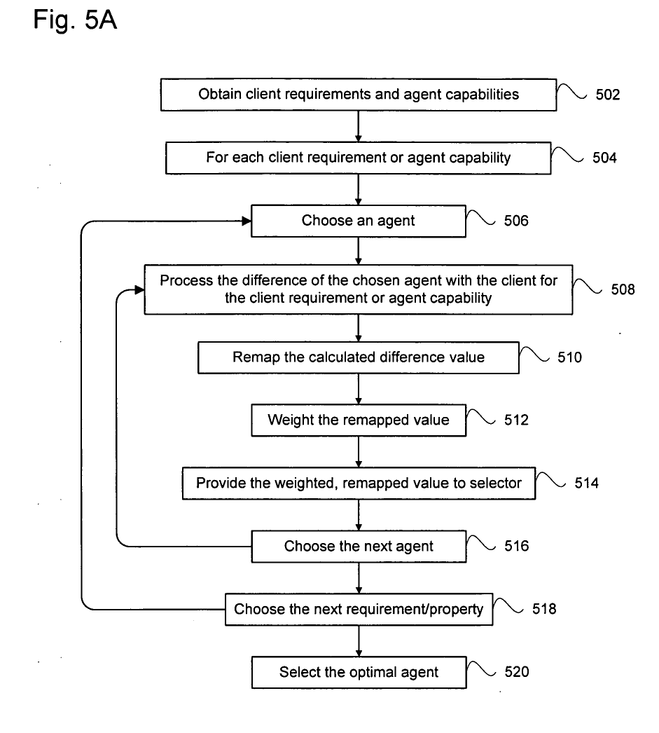

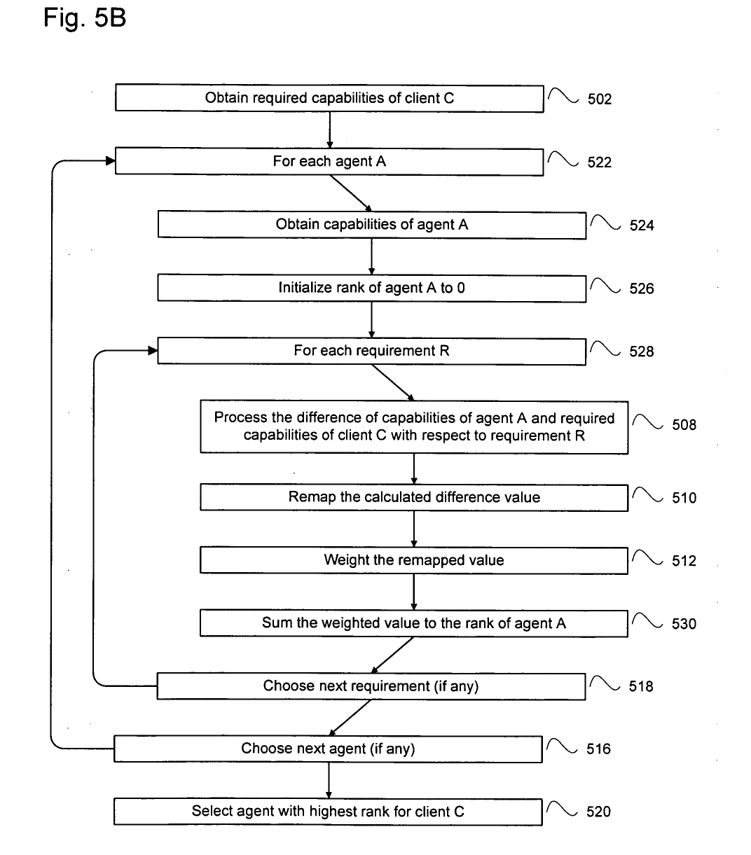

FIG. 5A is a flowchart depicting exemplary operation of the order distributor 204 of FIG. 4, according to one embodiment, upon receipt of an order request or customer presence signal/indication. The client requirements and agent capability properties are received by the receiver 206, as discussed above (block 502). It will be appreciated that the client requirements and agent capability properties may be received prior to, concurrent with or subsequent to the receipt of a customer presence indication. As shown in FIG. 4, the service provider 106, client 102 and agent 108 may provide relevant properties such as the client requirements, agent capabilities, customer information, or any other inputs, which may be received prior to, concurrent with or subsequent to the receipt of a customer presence indication. It will be appreciated that the client 102 and store 402 may be the same entity or they may be different entities, i.e. the client 102 may own and/or operate one or more stores 402 such as in a franchise arrangement. Accordingly, the client 102 and store 402 may provide different subsets of the inputs. For example, the store 402 may provide properties regarding the requirements needed for its customer 104. An outside service 404 may provide additional data/inputs, such as a weather information provider that provides weather forecasts, or other information providers which provide traffic information, local event/news information, etc., which may be provided prior to, concurrent with or subsequent to the receipt of a customer presence indication. The database 406 may include an internal memory or storage for the order distributor 204 and/or an external memory, storage or database, which stores and provides historical or previously provided data or properties that may be used in selecting an agent 108. For example, the quality of an agent 108 may be recorded in database 406 so that it can be used in selecting an agent 108 rather than requiring the system to retrieve that information from the client 102, service provider 106, or agent 108.

Each of the properties of client requirements and/or agent capabilities for each agent are then processed by the order distributor 204 (block 504), e.g. starting from a zero value total score, a score value is computed based on an analysis of each property/requirement and summed to the total score for later comparison among agents. As discussed below, in one embodiment the order distributor 204 may compare all of the agent capabilities of a given agent 108 with the client requirements of a particular client 102 and compute a resultant score value prior to performing the comparisons and computing a resultant score value for a subsequent agent 108, as shown in FIG. 5B. In an alternative embodiment, a particular capability of each agent 108 may be compared against the corresponding client requirement of the particular client 102 prior to comparing the next agent capability, as shown in FIG. 5A. It will be appreciated that the order in which agents 108 and their associated properties are analyzed is implementation dependent. For example, processing a given property across all agents before moving on to the next property, rather than all properties for each agent 108 before moving on to the next agent 108, may permit the order distributor 204 to eliminate agents 108 from contention early on thereby reducing subsequent processing. It will be appreciated that the set of agents 108 analyzed for selection may be pre-processed to minimize the number agents 108 subject to analysis or otherwise optimize the agent 108 data for more efficient analysis. For example, agents 108 who are not available, e.g. because they are not logged in, etc., may be immediately eliminated from further analysis. Further, the agent 108 data may be sorted, or otherwise comparisons of one or more agent capabilities may be performed among the agents 108, such that agents 108 more likely to match with the client requirements are analyzed first before less likely agents 108. In this way, the analysis and matching process is expedited. As shown in FIG. 4, the processor 208 receives the various inputs from the receiver 206 and performs the requisite comparisons and other operations as described below, and provides the results to the selector 210.

In performing a comparison of agents 108 with a client 102, the order distributor 204 may compare all of the agents 108 at the disposal of the order distributor or only a subset thereof (block 506). As shown in FIG. 4, each comparison operation compares a first property P₁ 412₁₋ₙ, which may be a property for an agent 108, e.g. an agent capability, against a second property P₂ 414₁₋ₙ, which may be a property from the client 102, e.g. the corresponding client requirement. As was described above, in one embodiment, comparison of a given property is performed across all agents 108 before comparison of a subsequent property is performed. Alternatively, comparison of all of the properties of a given agent 108 may be performed prior to comparison of another agent 108. The order in which properties and agents 108 are compared is implementation dependent.

For each comparison operation, a difference is calculated between the chosen agent 108 and the client 102 for the particular property (block 508). More specifically, the difference processor 416 of FIG. 4 may compare 1-n properties P₁ of the chosen agent 108 against the corresponding property P₂ of the client 102. In one embodiment, the difference processor 416, may perform the difference calculation using properties represented as integral properties or signed integers, such as where the property have a value selected from a range or set of possible values. Properties may also be treated as arrays of bits as discussed below, i.e. the values of multiple properties may be concatenated in a singular representation allowing them to be processed in a single operation. The following chart illustrates exemplary properties of a client 102, and their associate data type, that may be used by the difference processor 416. There may be additional properties that are considered, such as any of the properties/inputs discussed above with respect to FIG. 3.

| | Logical | |
|---|---|---|
| Name | Type | Description |
| PropertySet | Bit Array | Properties required by the store; bit #1: |
| | | English, bit #2: Spanish, bit #3: Fully |
| | | Trained, bit #4: Dessert Shop |
| RushHour | Integer | Specifies whether the store is in rush hour |
| Speed | Integer | Speed required based on quality of service |
| Accuracy | Integer | Accuracy required based on quality of |
| | | service |
| Friendliness | Integer | Friendliness required based on quality of |
| | | service |
| UpsellSuccess | Integer | Upsell Success required based on quality of |
| | | service |

In one embodiment, PropertySet may be a subset of properties such as the properties: English-speaking, Spanish-speaking, whether agent is fully trained, and familiarity with the type of store (dessert shop). As shown above, the PropertySet may be an array of bits, such a 4 bit binary value wherein each bit is representative of a property that the client 102 wants the selected agent 108 to possess or not possess, wherein a 1 represents that the property is required and a 0 represents that the property is not required. For example, according to the chart for a PropertySet, the four-bit array “1100” may represent that a store desires an agent 108 who speaks English and Spanish but is not fully trained and is not able to work in a dessert shop. A bit value or bit array may be used for those properties that are binary in nature, e.g. they are either present or not, true or false, etc. As shown above, other properties may be represented by an integer rather than a bit array wherein the property may have one or more of a range of values. The integer may be a ranking from 0-9 with 9 being the highest. Accordingly, a client 102 may require an agent 108 with a speed of at least 5 and an accuracy ranking of at least 7.

The following chart illustrates one example of the properties for an agent 108 that may be used by the difference processor 416. The properties for an agent 108 may be the same as the requirements for a client 102 as discussed above.

| | Logical | |
|---|---|---|
| Name | Type | Description |
| PropertySet | Bit Array | Properties of the agent; bit #1: English, |
| | | bit #2: Spanish, bit #3: Fully Trained, |
| | | bit #4: Dessert Shop |
| Speed | Integer | Speed of agent |
| LastUsedTime | Integer | Timestamp, encoded to integer, representing |
| | | the last time when the agent was chosen to |
| | | take an order (measured in elapsed time, |
| | | e.g. second, minutes, etc., or absolute time, |
| | | etc.) |
| Accuracy | Integer | Accuracy of agent |
| Friendliness | Integer | Friendliness of agent |
| UpsellSuccess | Integer | Upsell Success of agent |

As described above, a bit array or an integer may represent whether a property is possessed by an agent 108. For a bit array, a one indicates that the property is possessed and a zero indicates that a property is not possessed by the agent 108. According to the chart, a PropertySet with the four-bit bit array 1011 represents an agent 108 who speaks English, but not Spanish and is fully trained and can work in a dessert shop. Also, as discussed above, some properties may be represented by an integer rather than a bit array.

The following chart illustrates one example of a global property that is not directly associated with a client 102/store 402 or an agent 108. There may be additional global properties that are considered, such as any of the properties/inputs discussed above.

| Name | Logical Type | Description |
|---|---|---|
| CurrentTime | Integer | Timestamp, encoded to integer, representing |
| | | the time when the decision making process |
| | | was started |

All the properties listed above may be analyzed, compared and differentiated by the difference processor 416 by differentiating between property P₁ 412₁₋ₙ, and property P₂ 414₁₋ₙ. In one embodiment, the difference processor 416 may compare a property from each agent 108 with the corresponding client 102 property to determine a score for each agent 108. The comparison may determine if the agent 108 meets the client's minimum requirements. The difference processor 416 may perform a difference calculation such as a simple arithmetic difference or a bit difference as discussed below. In one embodiment, a simple arithmetic difference is used to compare and differentiate between properties represented as integers and the bit difference operation is used to compare and differentiate between properties represented by a bit array. Using the notation [symbol] for bit difference, the bit difference may be defined as a function of two bit arrays a and s returning an integer value as follows:

$$a ⊗ s = \{ \begin{matrix}cb ( a ) - cb ( s \& a ) , & if s = s \& a . \\ cb ( s \& a ) - cb ( s ) , & else ,\end{matrix}$$

where & denotes the bitwise and operator. The a may represent the PropertySet of an agent 108 and the s may represent the required PropertySet from a store 402 or client 102. The count-bits function cb(x) returns the number of 1 bits in the array representation of x. The bit difference operation may be used for comparing the required PropertySet for a client 102 with the PropertySet of an agent 108.

9] As discussed above, the PropertySet may be viewed as an array of bits with each bit representing a property. If that property is required by the client, then that property may be represented by a 1, but if it is not required, then it is represented by a zero. Likewise, for an agent 108, if the agent 108 possesses a particular property it is represented by a 1, but if the agent 108 does not have the property, then it is represented by a 0. Each bit in the array may represent a property that is present (1) or not present (0). The following table contains examples of the bit difference operation for sample client and agent PropertySets with a total of six properties.

| Client | Agent | | | |
|---|---|---|---|---|
| Property | Property | | | |
| Set (s) | Set (a) | & | [symbol] | Comment |
| 111001 | 111001 | 111001 | 0 | The store requires the same PropertySet that the |
| | | | | agent has. The bit difference is 0. |
| 111001 | 101001 | 101001 | −1 | The agent does not have the underlined property |
| | | | | required by the store. The bit difference is −1. |
| 111001 | 111111 | 111001 | +2 | The agent has all properties required and also |
| | | | | has 2 additional underlined properties. The bit |
| | | | | difference is +2. |
| 111001 | 111010 | 111000 | −1 | The agent does not have one of the properties |
| | | | | required, so the bit difference is −1 regardless of |
| | | | | the fact that the agent has 2 more properties than |
| | | | | required. |

As shown above, if the bit difference is zero, then the property set of the agent 108 exactly matches the client property set requirements. If the bit difference is negative then the agent 108 lacks a necessary property required by the client 102. If the bit difference is positive, then the agent 108 possesses additional properties that are not required by the client 102. In one embodiment, an agent 108 may be selected if the bit difference is zero or positive, but not negative.

The arithmetic difference may also be used by the difference processor 416 to compare properties P1 and P2. As discussed above, a property may be represented by an integer 0-9. If a client 102 requires a property with an integer value of 5 and for a particular agent 108 the property is only a 3, then the arithmetic difference is −2. As discussed above, a negative value means that the agent 108 has failed to meet the client's 102 requirement for that property. Likewise, a zero value means the agent 108 meets the client's 102 requirement for that property exactly, and a positive value means the agent 108 exceeds the client's 102 requirements for that property.

After the bit difference or other difference calculation is performed by the difference processor 416, the resulting difference value may be remapped (block 512). Referring to FIG. 4, the remapping may be performed by the remapping processor 418. The remapping processor 418 may be configured to scale or otherwise normalize the values that are calculated by the difference processor 416. In one embodiment, the remapping processor 418 may be unnecessary and the non-remapped values of the difference processor may be used in the selector 210, with or without passing through the weighting processor 420 as discussed below. Alternatively, the difference operation may be modified to replace the need for remapping of the difference values.

In one embodiment, dynamic remapping functions may be used to scale, balance and/or equalize the calculated difference values. In particular, where the bit difference or arithmetic difference is represented by an integer, it may not provide additional information regarding the significance of the integer. For example, two agents may each be represented by a difference calculation of +1, but depending on the extra property that each agent 108 possesses, assuming they are not the same, one agent may be more valuable than the other. The remapping may establish an increased value for the extra property of one of the clients 102. If one of the agents 108 speaks Spanish, which is not a requirement, that may be more valuable to a client 102 than an agent 108 that has a high upsell rate. Remapping may be used to redefine the significance of the values derived from the difference calculations. Remapping allows for a flexible method of assigning or redefining the value of the properties for each agent 108 compared with a client 102.

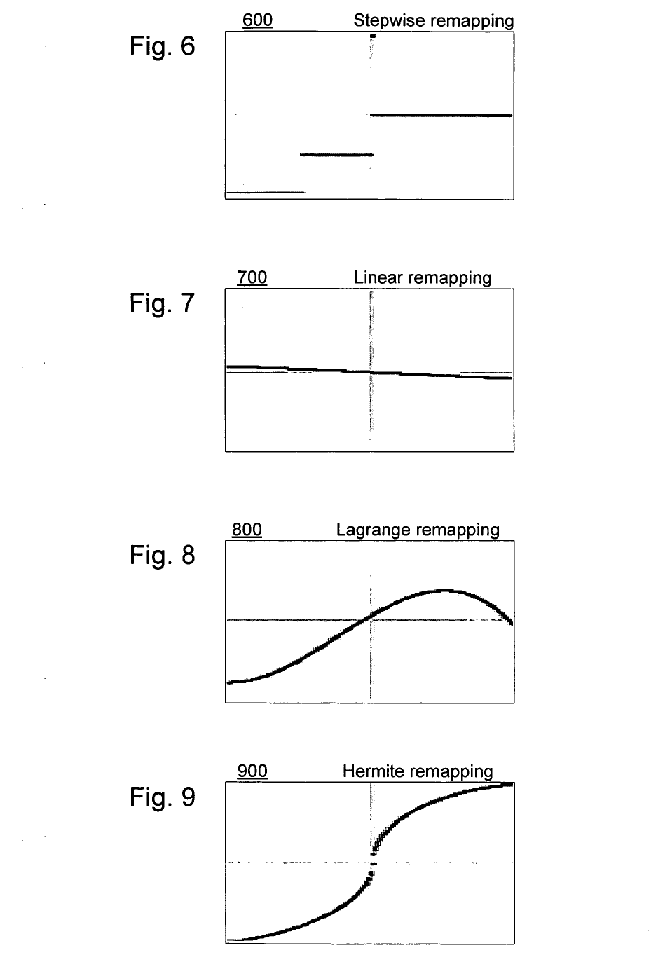

In one embodiment, the remap function is an integer valued function having one integer parameter, e.g. for a given input, the remap function returns an integer output representative of the remapped input according to the function. The remapping may be accomplished by computing the function value based on the input or, alternatively, using the input value to lookup the associated output value from a pre-calculated table of function values, such as a table stored in a database or content addressable memory. Given the difference “d” calculated in the difference processor 416, remapping with a remap function R is a calculation of R(d). Remap functions may be built up from different types of functions. FIGS. 6-9 illustrate four types of exemplary remap functions that may be used. It will be appreciated that other functions within or outside of the function classes containing the disclosed exemplary functions, or combinations thereof, may also be used.

FIG. 6 is a chart depicting an exemplary stepwise remapping 600 function for use with the disclosed embodiments. Stepwise remapping maps the value or parameter to a constant value for given intervals. FIG. 7 is a chart depicting an exemplary linear remapping function 700 for use with the disclosed embodiments. Linear remapping may use a simple linear function to remap values. The stepwise remapping 600 may be defined by combining linear functions; however, stepwise remapping may be a shortcut to specific linear functions. FIG. 8 is a chart depicting an exemplary Lagrange remapping function 800 for use with the disclosed embodiments. Lagrange remapping uses Lagrange interpolation and assigns function values based on the interpolation. Any linear remapping 700 or stepwise remapping 600 may be defined by combining Lagrange interpolations. Accordingly, linear remapping 700 and stepwise remapping 600 may be considered as shortcuts for Lagrange remapping. FIG. 9 is a chart depicting an exemplary Hermite remapping function 900 for use with the disclosed embodiments. Hermite remapping uses Hermite curve interpolation, i.e. a Hermite polynomial which is type of orthogonal polynomial, and assigns function values based on the curve. Hermite remapping may be more useful than Lagrange interpolation, since the tangent of the curve may be varied in addition to the position of the control points. A particular function is selected to remap a particular property value based on the desired influence that property is to have in the selection process as well as the nature of the property itself and the types of values it may have. Particular functions may accentuate or emphasize particular property values increasing their influence on the selection process, for example for higher priority properties, while deemphasizing lesser important properties and prevent them from dominating the selection process. Further, non-linear functions may be used to accentuate particular values or ranges of values while deemphasizing outlier values, e.g. reflecting diminished returns of values outside of the given ranges.

For performance reasons, all remap functions may be pre-calculated and stored as an array of integers. Accordingly, during the decision-making process, remapping may only require a lookup in an integer array. As shown in FIG. 4, each of the remapping processors 418, is coupled with a remapping database 419. The remapping database 419 may store remapped values that are used by the remapping processor 418. The remapping processor 418 may also transmit any remapping calculations that are performed to the remapping database 419 for storage and for potential future use. The remapping database 419 may include hash tables to speed up searching by certain properties, such as by an identification of the client 102 or agent 108.

After the difference value is remapped, the resulting remapped value may be multiplied by a weight value (block 512) to further emphasize or deemphasize the value in the overall selection process depending on the priority of the given property. As shown in FIG. 4, the weighting processor 420 receives the remapped value and may produce a score that is representative of the compatibility of a particular agent 108 with a client 102. Each value from the remapping function may be multiplied by a weight value. The weight value may be associated with the given property that is being compared and the values may be stored in a weighting database 421. The weighting may include the multiplication of the remapped value with the integer valued weight to produce a score.

The following chart illustrates a sample comparison of a number of properties.

| Property 1 | Property 2 | Diff | Remapper | Weight | Description |
|---|---|---|---|---|---|
| Agent.PropertySet | Store.PropertySet | Bit | Stepwise | 1000 | Implements required |
| (required) | (required) | | Remapping | | property. Due to the |
| | | | (FIG. 5) | | remapper, agents with |
| | | | | | at least 1 missing |
| | | | | | property will get the |
| | | | | | lowest score, while |
| | | | | | agents with excess |
| | | | | | properties may not be |
| | | | | | preferred. |
| Global.CurrentTime | Agent. | Arith | Hermite | 100 | Order Distributor |
| | LastUsedTime | | Remapping | | (“OD”) tries to utilize |
| | | | (FIG. 8) | | agents at same level. |
| Agent.PropertySet | Store.PropertySet | Bit | Linear | 10 | OD does not choose |
| | | | Remapping | | agents having more |
| | | | (FIG. 6) | | properties than |
| | | | | | required. |
| Store.RushHour | Agent.Speed | Arith | Lagrange | 5 | OD chooses faster |
| | | | Remapping | | agent for stores in rush |
| | | | (FIG. 7) | | hour. |
| Store.Speed | Agent.Speed | Arith | Lagrange | 1 | OD chooses agents |
| | | | Remapping | | appropriate for service |
| | | | (FIG. 7) | | level in terms of |
| | | | | | speed. |
| Store.Accuracy | Agent.Accuracy | Arith | Lagrange | 1 | OD chooses agents |
| | | | Remapping | | appropriate for service |
| | | | (FIG. 7) | | level in terms of |
| | | | | | accuracy. |
| Store.Friendliness | Agent.Friendliness | Arith | Lagrange | 1 | OD chooses agents |
| | | | Remapping | | appropriate for service |
| | | | (FIG. 7) | | level in terms of |
| | | | | | friendliness. |
| Store.UpsellSuccess | Agent.UpsellSuccess | Arith | Lagrange | 1 | OD chooses agents |
| | | | Remapping | | appropriate for service |
| | | | (FIG. 7) | | level in terms of upsell |
| | | | | | success. |

As shown above, there is a comparison for individual properties for an agent 108 and a store 402/client 102. The difference calculation may be the bit difference or arithmetic difference as discussed above. The remapping function for a particular property is shown in the remapper column. The weight for each property is shown such that the difference of the agents 108 with the client 102 is multiplied by 1000, whereas the “speed” is multiplied by one. This suggests that the required properties are worth 1000 times more than the properties whose weight is only one. The resulting value is the ranking of a particular agent and will be referred to herein as the score of an agent 108. Weighting may be used to bias certain properties and account for those properties considered to be of higher value or higher reliability in selecting an appropriate agent 108 while discounting, without necessarily eliminating, lower value or lower reliability properties.

It will be appreciated that the processor 208 may include one or more processors, such as one or more micro-processors, coupled together and operating serially or in parallel. The difference processor 416, remapping processor 418 and weighting processor 420 may be implemented in hardware, such as a micro-processor or as hard wired logic of the processor 208, or in software and executed on the one or more processors of the processor 208. In one embodiment, the processor 208 is implemented as one or more general purpose processors, such as ×86 class processors, capable of multi-threaded execution. In this embodiment, the difference processor 416, remapping processor 418 and weighting processor 420 are implemented as software processes executed by the processor 208 wherein more than one instance of the difference processor 416, remapping processor 418 and weighting processor 420 may execute in parallel or serially to implement the functionality described above.

1] The remapped and weighted score values for the agents 108 and/or properties are then passed to the selector 210 (block 514) which may sum the values as they are computed to calculate a total score. Alternatively, as shown in FIG. 5B, as the properties of the given agent are compared against the requirements, the computed scores are summed to calculate an overall score for the agent 108 before moving to the next agent 108 (blocks 526, 528, 508, 510, 512, 530, 518, 516). As shown in FIG. 4, the selector 210 analyzes the scores that it receives from each agent 108 for each property as compared with a particular client 102. The selector 210 may then match an agent 108 with a particular client 102 for a call based on the scores. The order distributor 204 may have a score definition list containing one or more scores (property₁, property₂, type of difference, etc.) to use for comparisons between agents 108 in order to match an agent 108 with a client 102. The score definition list may be stored in a quickly accessible in-memory data structure and may be read from a configuration file that can be updated at any time.

2] Another agent 108 may then be chosen to be compared with the client 102 for the particular property (block 516). The process cycles through each agent 108, then a different property may be chosen (block 518). The different property is then analyzed for each agent 108. Accordingly, for each property, each agent 108 is compared with the client 102 for the particular property as described above (blocks 508-514). In an alternate embodiment, an agent 108 is compared with the client 102 for each property, before moving to the next agent 108.

After a comparison has been made between the client 102 and each agent 108 over each property, the optimal agent may then be selected (block 520). Referring back to FIG. 4, the selector 210 may compare the scores of agents 108 to determine the optimal agent for a give client 102, store 402 or customer 104. In particular, Store S may ask the order distributor 204 to choose the optimal agent 108 to take a call and an order. Agents 108 may be designated as A₁, A₂, . . . , Aₙ. The order distributor 204 analyzes the agents 108 by calculating an integer value (the rank/score) of every agent Aᵢ with respect to store S. As described above, the rank may be calculated by the following formula:

R(Aᵢ)=Σⱼwⱼ·mⱼ(pⱼ¹(store, agent, global) ⋄ pⱼ²(store, agent, global)),

where pⱼ¹(store, agent, global) and pⱼ²(store, agent, global) denotes the value of property₁ and property₂, which may be properties of the client 102 store 402, of different agents 108 or a global property. As discussed above, ⋄ denotes the operation of either arithmetical or bit difference, mⱼ denotes the mapping function and wⱼ denotes the weight for the j^{th} score. Accordingly, the formula above may be used to calculate a score for a particular agent 108 compared with a client 102. The scores for the agents 108 are used by the selector 210 to choose the optimal agent 108. In alternate embodiments, the scores that the selector 210 compares may be computed differently, using a different formula, or different variables.

During calculation of the scores of agents, the order distributor 204 tracks the agent 108 with the highest score. If the highest score is greater or equal to a predefined value, such as a minimum score, the agent 108 with the highest score may be chosen to be the optimal agent to take the call. If no agent 108 satisfies the minimum score, the call may be dropped because no agents 108 satisfy the client's 102 minimum requirements.

In one embodiment, exemplary operation of the order distributor 204 may be as follows:

### Examples of Decision Making Process of the Order Distributor 204

This example assumes that the order distributor 204 is working with the score functions as shown in the table below implementing requirements against the decision making process. It is further assumed that the present time is 1000 (which may be measured in any unit of time, e.g. seconds, milliseconds, etc., which does not matter for the example).

| Property 1 | Property 2 | Diff | Remapper | Weight | Description |
|---|---|---|---|---|---|
| Agent.PropertySet | Store.PropertySet | Bit | Stepwise | 1000 | Implements required |
| (required) | (required) | | Remapping | | property. Due to the |
| | | | (FIG. 5) | | selected remapping |
| | | | | | function used by the |
| | | | | | remapping processor |
| | | | | | 418, agents 108 with |
| | | | | | at least 1 missing |
| | | | | | property will get the |
| | | | | | lowest score, while |
| | | | | | agents 108 with |
| | | | | | excess properties may |
| | | | | | not be preferred. |
| Global.CurrentTime | Agent. | Arith | Hermite | 100 | Order Distributor 204 |
| | LastUsedTime | | Remapping | | tries to utilize agents |
| | | | (FIG. 8) | | 108 at same level. |
| Agent.PropertySet | Store.PropertySet | Bit | Linear | 10 | Order Distributor |
| | | | Remapping | | 204does not choose |
| | | | (FIG. 6) | | agents 108 having |
| | | | | | more properties than |
| | | | | | required. |
| Store.RushHour | Agent.Speed | Arith | Lagrange | 5 | Order Distributor |
| | | | Remapping | | 204chooses faster |
| | | | (FIG. 7) | | agent 108 or stores in |
| | | | | | rush hour. |
| Store.Speed | Agent.Speed | Arith | Lagrange | 1 | Order Distributor |
| | | | Remapping | | 204chooses agents |
| | | | (FIG. 7) | | 108 appropriate for |
| | | | | | service level in terms |
| | | | | | of speed. |
| Store.Accuracy | Agent.Accuracy | Arith | Lagrange | 1 | Order Distributor |
| | | | Remapping | | 204chooses agents |
| | | | (FIG. 7) | | 108 appropriate for |
| | | | | | service level in terms |
| | | | | | of accuracy. |
| Store.Friendliness | Agent.Friendliness | Arith | Lagrange | 1 | Order Distributor |
| | | | Remapping | | 204chooses agents |
| | | | (FIG. 7) | | 108 appropriate for |
| | | | | | service level in terms |
| | | | | | of friendliness. |
| Store.UpsellSuccess | Agent.UpsellSuccess | Arith | Lagrange | 1 | Order Distributor |
| | | | Remapping | | 204chooses agents |
| | | | (FIG. 7) | | 108 appropriate for |
| | | | | | service level in terms |
| | | | | | of up-sell success. |

From the above table it can be seen that bit differences are used for the 1st and 3rd requirements and arithmetic differences are used for all other comparisons. As was discussed, bit differences are used for requirements which compare required PropertySets of clients (stores) or PropertySets of agents 108, i.e., PropertySets represent a set of skills which cannot be simply subtracted from each other.

For example, suppose there are three skills, English, Spanish and Dessert (which could mean deep knowledge of all desserts). The three skills are represented by binary numbers consisting of 3 digits of 0 and 1, like 001, 110, etc.

Assuming a store requires a Spanish speaking agent 108 who is familiar with all desserts, and assume that there is an agent 108 who speaks English but not Spanish and is familiar with all desserts. In this case, the required property set of the store is 011, while the property set of the agent is 101. Clearly, it cannot be said that the difference of the two property sets is zero, just because both property sets have the same number of elements, and a simple arithmetic difference may not work either to find out whether the agent satisfies the store's needs. Accordingly, the bit difference operation is utilized which gives a result of −1, in this case meaning that the agent 108 doesn't speak Spanish (is missing 1 required property).

All other requirements in the table can be handled with simple arithmetic difference, since they are “normal” integer values. Like the difference calculation between the current time and the agent's 108 last used time property can be calculated by a simple arithmetic operation. If an agent 108 was used at the 972nd second and the current time is 1000, then the agent 108 was used 1000−972=28 seconds ago.

On the other hand, for “normal” integer values it may not make sense to use bit difference, furthermore it may not make sense to compare property sets with integer values neither with arithmetic nor with bit difference.

One more interesting point derived from the above table is that the property set of the agent 108 and the store is compared twice, using two different remapping functions and two different weights. The first comparison implements a requirement which ensures that the chosen agent 108 does have the capabilities required by the store. The second comparison implements a requirement which ensures that if there are more than one agents 108 who have the capabilities required by the store, then order distributor 204 will try to choose an agent 108 from among those agents 108 who doesn't have more capabilities than needed.

In one embodiment, these two requirements could be merged into one, but in alternate embodiments, the priority of the 2nd requirement (proper utilization of agents 108) is less than the 1st but more than a 3rd requirement, i.e. the current business need, as defined by the entire set of requirements in the table. Thereby, the model is absolutely capable to compare any properties any times. As was discussed, the properties that the order distributor 204 considers, as defined by the business need, overall or on a client 102 by client 102 basis, and the priority with which each property is factored into the selection process, is implementation dependent and depends upon the business requirements of the parties involved.

### EXAMPLE #1

In the following example, it is assumed that the order distributor 204 is handling two agents and receives an order route request from a client 102 (store). The required capabilities and the capabilities of agents 108 are summarized in the table below along with the current time.

| | Required by | | | |
|---|---|---|---|---|
| | Client 102 | Agent 1 108 | Agent 2 108 | |
| | (Store) | having | having | Global |
| PropertySet | 0111 | 0111 | 1111 | N/A |
| Speed | 50 | 50 | 50 | N/A |
| LastUsedTime | N/A | 787 | 971 | N/A |
| Accuracy | 50 | 50 | 50 | N/A |
| Friendliness | 50 | 50 | 50 | N/A |
| UpsellSuccess | 50 | 50 | 50 | N/A |
| CurrentTime | N/A | N/A | N/A | 1000 |

Given this information, the order distributor 204 calculates rank of the first agent (1) 108 as shown in the following table:

| Property 1 | Property 2 | Diff | Remapper | Weight |
|---|---|---|---|---|
| Agent.PropertySet = 0111 | Store.PropertySet = 0111 | BitDifference = 0 | Stepwise | Weighted with |
| | | | Remapped value = 0 | 1000 = 0 |
| Global.CurrentTime = 1000 | Agent. | Arithmetic | Hermite | Weighted with |
| | LastUsedTime = 787 | difference = 213 | Remapped value = 128 | 100 = 128000 |
| Agent.PropertySet = 0111 | Store.PropertySet = 0111 | BitDifference = 0 | Linear | Weighted with |
| | | | Remapped value = 0 | 10 = 0 |
| Store.RushHour = 50 | Agent.Speed = 50 | Arithmetic | Lagrange | Weighted with 5 = 100 |
| | | difference = 0 | Remapped value = 20 | |
| Store.Speed = 50 | Agent.Speed = 50 | Arithmetic | Lagrange | Weighted with 1 = 20 |
| | | difference = 0 | Remapped value = 20 | |
| Store.Accuracy = 50 | Agent.Accuracy = 50 | Arithmetic | Lagrange | Weighted with 1 = 20 |
| | | difference = 0 | Remapped value = 20 | |
| Store.Friendliness = 50 | Agent.Friendliness = 50 | Arithmetic | Lagrange | Weighted with 1 = 20 |
| | | difference = 0 | Remapped value = 20 | |
| Store.UpsellSuccess = 50 | Agent.UpsellSuccess = 50 | Arithmetic | Lagrange | Weighted with 1 = 20 |
| | | difference = 0 | Remapped value = 20 | |

| | |
|---|---|
| Sum of weighted values, that is, rank of agent = | 12980 |

Analogously, the order distributor 204 calculates rank of the second Agent (2) 108 as shown in the following table:

| Property 1 | Property 2 | Diff | Remapper | Weight |
|---|---|---|---|---|
| Agent.PropertySet = 1111 | Store.PropertySet = 0111 | BitDifference = 1 | Stepwise | Weighted with |
| | | | Remapped value = 0 | 1000 = 0 |
| Global.CurrentTime = 1000 | Agent. | Arithmetic | Hermite | Weighted with |
| | LastUsedTime = 971 | difference = 29 | Remapped value = 77 | 100 = 7700 |
| Agent.PropertySet = 1111 | Store.PropertySet = 0111 | BitDifference = 1 | Linear | Weighted with |
| | | | Remapped value = −10 | 10 = −100 |
| Store.RushHour = 50 | Agent.Speed = 50 | Arithmetic | Lagrange | Weighted with 5 = 100 |
| | | difference = 0 | Remapped value = 20 | |
| Store.Speed = 50 | Agent.Speed = 50 | Arithmetic | Lagrange | Weighted with 1 = 20 |
| | | difference = 0 | Remapped value = 20 | |
| Store.Accuracy = 50 | Agent.Accuracy = 50 | Arithmetic | Lagrange | Weighted with 1 = 20 |
| | | difference = 0 | Remapped value = 20 | |
| Store.Friendliness = 50 | Agent.Friendliness = 50 | Arithmetic | Lagrange | Weighted with 1 = 20 |
| | | difference = 0 | Remapped value = 20 | |
| Store.UpsellSuccess = 50 | Agent.UpsellSuccess = 50 | Arithmetic | Lagrange | Weighted with 1 = 20 |
| | | difference = 0 | Remapped value = 20 | |

| | |
|---|---|
| Sum of weighted values, that is, rank of agent = | 7780 |

As can be seen from the previous tables, the rank of the first Agent (1) 108 is higher than the rank of the second Agent (2) 108, therefore the order distributor 204 selects the first Agent (1) 108 to take the call.

### EXAMPLE #2

In the previous example, the difference between agent 108 ranks was primarily caused by the difference in their LastUsedTime property. In the present example, the LastUsedTime property of the first Agent (1) 108 is modified to be the same as for the second Agent (2) 108.

| | Required by | Agent 1 108 | Agent 2 108 | |
|---|---|---|---|---|
| | Client (Store) | having | having | Global |
| PropertySet | 0111 | 0111 | 1111 | N/A |
| Speed | 50 | 50 | 50 | N/A |
| LastUsedTime | N/A | 971 | 971 | N/A |
| Accuracy | 50 | 50 | 50 | N/A |
| Friendliness | 50 | 50 | 50 | N/A |
| UpsellSuccess | 50 | 50 | 50 | N/A |
| CurrentTime | N/A | N/A | N/A | 1000 |

Given this updated scenario, the order distributor 204 calculates the rank of the first agent (1) 108 as shown in the following table:

| Property 1 | Property 2 | Diff | Remapper | Weight |
|---|---|---|---|---|
| Agent.PropertySet = 0111 | Store.PropertySet = 0111 | BitDifference = 0 | Stepwise | Weighted with |
| | | | Remapped value = 0 | 1000 = 0 |
| Global.CurrentTime = 1000 | Agent. | Arithmetic | Hermite | Weighted with |
| | LastUsedTime = 971 | difference = 29 | Remapped value = 77 | 100 = 7700 |
| Agent.PropertySet = 0111 | Store.PropertySet = 0111 | BitDifference = 0 | Linear | Weighted with |
| | | | Remapped value = 0 | 10 = 0 |
| Store.RushHour = 50 | Agent.Speed = 50 | Arithmetic | Lagrange | Weighted with 5 = 100 |
| | | difference = 0 | Remapped value = 20 | |
| Store.Speed = 50 | Agent.Speed = 50 | Arithmetic | Lagrange | Weighted with 1 = 20 |
| | | difference = 0 | Remapped value = 20 | |
| Store.Accuracy = 50 | Agent.Accuracy = 50 | Arithmetic | Lagrange | Weighted with 1 = 20 |
| | | difference = 0 | Remapped value = 20 | |
| Store.Friendliness = 50 | Agent.Friendliness = 50 | Arithmetic | Lagrange | Weighted with 1 = 20 |
| | | difference = 0 | Remapped value = 20 | |
| Store.UpsellSuccess = 50 | Agent.UpsellSuccess = 50 | Arithmetic | Lagrange | Weighted with 1 = 20 |
| | | difference = 0 | Remapped value = 20 | |

| | |
|---|---|
| Sum of weighted values, that is, rank of agent = | 7880 |

As can be seen, the rank of the second Agent (2) 108 has not changed, i.e. all properties of the second Agent (2) 108 and all decision making requirements remained the same in this example. Therefore, in this case the order distributor 204 still selects the first Agent (1) 108 to take the order. It can be seen that, in this example, the difference of 100 between ranks is caused by the ₃rd requirement, which makes the order distributor 204 to try to not choose agents 108 having more capabilities than needed.

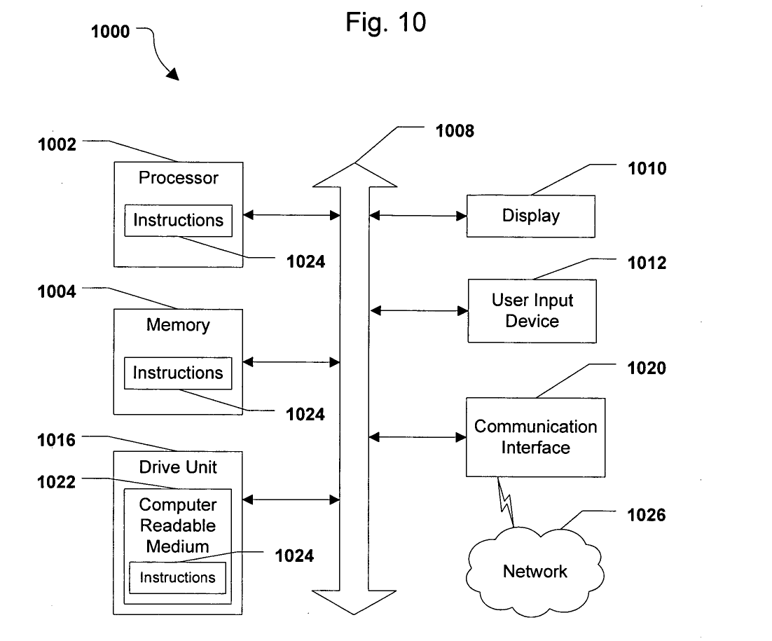

The order distributor 204 may be implemented on a computer system 1000 such as shown in FIG. 10. In addition, the client 102, service provider 106, agent 108, remapping database 419, weighting database 421, processors 416-418, or other components in FIGS. 1, 2 and 4 may also be implemented on a same or different computer system 1000 as shown in FIG. 10. The computer system 1000 may include a set of instructions, implemented in logic or a computer program, that can be executed to cause the computer system 1000 to perform any one or more of the methods or computer based functions disclosed herein, such as the matching of an agent 108 with a client/customer. The computer system 1000 may operate as a standalone device or may be connected, e.g., using a network, to other computer systems or peripheral devices.

In a networked deployment, the computer system 1000 may operate in the capacity of a server or as a client user computer in a server-client user network environment, or as a peer computer system in a peer-to-peer (or distributed) network environment. The computer system 1000 can also be implemented as or incorporated into various devices, such as a personal computer (“PC”), a tablet PC, a set-top box (“STB”), a personal digital assistant (“PDA”), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (“CPU”), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one embodiment, the memory 1004 includes a cache or random access memory for the processor 1002. In alternative embodiments, the memory 1004 is separate from the processor 1002, such as a cache memory of a processor, the system memory, or other memory. The memory 1004 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 1004 is operable to store instructions executable by the processor 1002. The functions, acts or tasks illustrated in the figures or described herein may be performed by the programmed processor 1002 executing the instructions stored in the memory 1004. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 1000 may further include a display unit 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006.

Additionally, the computer system 1000 may include an input device 1016 configured to allow a user to interact with any of the components of system 1000. The input device 1016 may be a number pad, a keyboard, or a cursor control device, such as a mouse, or a joystick, touch screen display, remote control or any other device operative to interact with the system 1000.

In a particular embodiment, as depicted in FIG. 10, the computer system 1000 may also include a disk or optical drive unit 1006. The disk drive unit 1006 may include a computer-readable medium 1010 in which one or more sets of instructions 1012, e.g. software, can be embedded. Further, the instructions 1012 may embody one or more of the methods or logic as described herein. In a particular embodiment, the instructions 1012 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium that includes instructions 1012 or receives and executes instructions 1012 responsive to a propagated signal, so that a device connected to a network 1020 can communicate voice, video, audio, images or any other data over the network 1020. Further, the instructions 1012 may be transmitted or received over the network 1020 via a communication port 1018. The communication port 1018 may be a part of the processor 1002 or may be a separate component. The communication port 1018 may be created in software or may be a physical connection in hardware. The communication port 1018 is configured to connect with a network 1020, external media, the display 1014, or any other components in system 1000, or combinations thereof. The connection with the network 1020 may be a physical connection, such as a wired Ethernet connection or may be established wirelessly as discussed below. Likewise, the additional connections with other components of the system 1000 may be physical connections or may be established wirelessly.

The network 1020 may include wired networks, wireless networks, or combinations thereof. The wireless network may be a cellular telephone network, an 802.11, 802.16, 802.20, or WiMax network. Further, the network 1020 may be a public network, such as the Internet, a private network, such as an intranet, or combinations thereof, and may utilize a variety of networking protocols now available or later developed including, but not limited to TCP/IP based networking protocols.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

It is therefore intended that the foregoing detailed description be regarded as illustrative rather than limiting, and that it be understood that it is the following claims, including all equivalents, that are intended to define the spirit and scope of this invention.

1. A method for selecting an agent for a client comprising:
receiving a request to select an agent to handle a transaction;
receiving capability information relating to capabilities of at least one of a plurality of agents;
receiving client requirements based on the needs of the client;
processing the capability information and the client requirements; and
selecting an agent from the plurality of agents based on the processed information in response to the request.

2. The method of claim 1, further comprising:
initiating communication by the selected agent to handle the transaction.

3. The method of claim 2, wherein the initiating further comprises initiating an audio connection by the selected agent to handle the transaction.

4. The method of claim 1, wherein the request is received non-telephonically.

5. The method according to claim 1 wherein the capability information includes at least one of availability, cost, profit margin, experience, quality, or combinations thereof.

6. The method according to claim 5 wherein the quality includes at least one of objective considerations, subjective considerations, or combinations thereof.

7. The method according to claim 6 wherein the objective considerations include at least one of reported incidents, accuracy, selling process, technical issues, speed, revenue generated, reliability, language, familiarity, available software, or combinations thereof.

8. The method according to claim 6 wherein the subjective considerations include at least one of friendliness, customer service, or combinations thereof.

9. The method according to claim 1 wherein the client requirements includes at least one of static considerations, dynamic considerations, or combinations thereof.

10. The method according to claim 9 wherein the static considerations include order entry type, location, number of workers, workers on break, promotions, coupons, specials, store priority, or combinations thereof.

11. The method according to claim 9 wherein the dynamic considerations include price, agent capability, product demand, queue length, inventory, wait time, customer information, reliability, or combinations thereof.

12. The method according to claim 1, wherein the selection of an agent is based on a comparison of a ranking of the plurality of agents.

13. The method according to claim 12, wherein the ranking of the plurality of agents is calculated by: R(Aᵢ)=Σⱼwⱼ·mⱼ(pⱼ¹(store, agent, global) ⋄ pⱼ²(store, agent, global)), where pⱼ¹(store, agent, global) and pⱼ²(store, agent, global) denote the value of property₁ and property₂, ⋄ denotes a bit difference operation, mⱼ denotes a mapping function and wⱼ denotes a weight for the j^{th} score.

14. A method for connecting an agent with a customer comprising:
receiving a signal requesting a connection with the customer, wherein the customer is associated with a client;
receiving capability information relating to capabilities of at least one of a plurality of agents;
receiving client requirements associated with the client;
processing the capability information and the client requirements;
selecting an agent from the plurality of agents based on the processed information in response to the signal; and
establishing the connection between a customer and the selected agent.

15. The method according to claim 14 wherein the signal requesting a connection is received from the client.

16. The method according to claim 15, wherein the signal is received non-telephonically.

17. The method according to claim 14 where the establishing further comprises establishing the connection from the selected agent to the customer.

18. The method according to claim 14 wherein the client requirements relate to data associated with the client, the data including order entry type, location, number of workers, workers on break, promotions, coupons, specials, store priority, price, agent capability, product demand, queue length, inventory, wait time, customer information, reliability, or combinations thereof.

19. The method according to claim 14 wherein the capability information includes at least one of availability, cost, profit margin, experience, quality, or combinations thereof.

20. The method according to claim 19 wherein the quality includes reported incidents, accuracy, selling process, technical issues, speed, revenue generated, reliability, language, familiarity, available software, friendliness, customer service, or combinations thereof.

21. The method according to claim 14 wherein the processing includes developing a score for the plurality of agents.

22. The method according to claim 21 wherein the score is derived from the equation: Σⱼwⱼ·mⱼ(pⱼ¹(store, agent, global) ⋄ pⱼ²(store, agent, global)), where pⱼ¹(store, agent, global) and pⱼ²(store, agent, global) denote the value of property₁ and property₂, ⋄ denotes a bit difference operation, mⱼ denotes a mapping function and wⱼ denotes a weight for the j^{th} score.

23. A system for selecting an optimal agent from a plurality of agents for communication with a customer associated with a client, the system comprising:
a request receiver configured to receive a signal requesting a connection with the customer;
an input receiver configured to receive inputs, the inputs relating to at least one of agent capability information for at least one of the plurality of agents, client requirements of the client, or combinations thereof;
a processor coupled with the input receiver and configured to analyze the inputs to compare the agent capability information with the client requirements and rank the plurality of agents based thereon; and
a selector coupled with the processor and the request receiver and configured to select the optimal agent from the plurality of agents based on the rank in response to receipt of the signal.

24. The system according to claim 23 wherein the processor further comprises:
a difference processor configured to compare the agent capability information with the client requirements to derive a first value for each of the plurality of agents;
a remapping processor coupled with the difference processor and configured to adjust the first value for each of the plurality of agents to a second value; and
a weighting processor coupled with the remapping processor and configured to multiply each of the second values for each of the plurality of agents by an appropriate weight assigned to each comparison.

25. The system according to claim 24 wherein the difference processor comprises a bit difference operation to compare the agent capability information with the client requirements.

26. The system according to claim 23 wherein the client requirements relate to data associated with the client, the data including order entry type, location, number of workers, workers on break, promotions, coupons, specials, store priority, price, agent capability, product demand, queue length, inventory, wait time, customer information, reliability, or combinations thereof.

27. The system according to claim 23 wherein the agent capability information includes at least one of availability, cost, profit margin, experience, quality, such as reported incidents, accuracy, selling process, technical issues, speed, revenue generated, reliability, language, familiarity, available software, friendliness, customer service, or combinations thereof.

28. The system according to claim 23 wherein the plurality of agents may be a subset of available agents.

29. A system for connecting an agent with a customer comprising:
means for receiving a signal requesting a connection for the customer, wherein the customer is associated with a client;
means, coupled with the means for receiving a signal, for receiving capability information relating to capabilities of at least one of a plurality of agents;
means, coupled with the means for receiving a signal, for receiving client requirements;
means, coupled with the means for receiving capability information and the means for receiving client requirements, for processing the capability information and the client requirements;
means, coupled with the means for processing, for selecting an agent from the plurality of agents based at least partially on the processed information; and
means, coupled with the means for selecting, for establishing the connection between a customer and the selected agent.
